(19) United States
(12) Patent Application Publication
(10) Pub. No.: US 2014/0151460 A1
(43) Pub. Date: Jun. 5, 2014

(54) SYSTEM AND METHOD FOR MAINTAINING SENSOR PERFORMANCE

(71) Applicant: GENERAL ELECTRIC COMPANY, Schenectady, NY (US)

(72) Inventors: Joseph Forrest Noffsinger, Grain Valley, MO (US); John Kramer, Shelton, CT (US); Bret Dwayne Worden, Erie, PA (US); Ajith Kumar, Erie, PA (US)

(21) Appl. No.: 14/093,998

(22) Filed: Dec. 2, 2013

Related U.S. Application Data
(63) Continuation-in-part of application No. 13/816,036, filed on Apr. 5, 2013.
(60) Provisional application No. 61/732,389, filed on Dec. 2, 2012.

(51) Int. Cl. B05B 12/02

(52) U.S. Cl. CPC B05B 12/02
USPC 239/69; 239/302; 239/135

(57) ABSTRACT

A system for use with a vehicle includes at least one nozzle and an fluid reservoir capable of holding a volume of pressurized gas or other fluid. The air reservoir is in fluid communication with the at least one nozzle and the at least one nozzle is selectively operable to direct the pressurized gas or other fluid at a surface of an optical inspection sensor assembly to remove contaminants from the sensor assembly.

### CROSS REFERENCE TO RELATED APPLICATIONS

This application is a continuation in part of U.S. Ser. No. 13/816,036 filed on Apr. 5, 2013, and also claims the benefit of provisional patent application Ser. No. 61/732,389, filed on Dec. 2, 2012, both of which are hereby incorporated by reference in their entireties.

### TECHNICAL FIELD

Embodiments of the invention relate to a system for maintaining sensor performance and associated methods.

### DISCUSSION OF ART

It is sometimes desired in the rail industry to increase the tractive force of a locomotive to facilitate the transport of large and heavy cargo. Tractive force is the pulling or pushing force exerted by a vehicle, machine or body. As used in the rail industry, tractive effort (which is synonymous with tractive force) is the pulling or pushing capability of a locomotive, i.e., the pull force a locomotive is capable of generating. Tractive effort further may be classified as starting tractive effort, maximum tractive effort and continuous tractive effort. Starting tractive effort is the tractive force that can be generated at a standstill. Starting tractive effort is of great importance in railway engineering because it limits the maximum weight that a locomotive can set in motion from a dead stop. Maximum tractive effort is the maximum pulling force of the locomotive or vehicle and continuous tractive effort is the pulling force that can be generated by the locomotive or vehicle at any given speed. Additionally, tractive effort applies to stopping capability.

Tractive adhesion, or simply, adhesion, is the grip or friction between a wheel and the surface supporting the wheel. Adhesion is based in large part on friction, with maximum tangential force producible by a driving wheel before slipping given by:

Fmax=(coefficient of friction)·(weight on wheel)·(gravity)

For a long, heavy train to accelerate from standstill at a desired acceleration rate, the locomotive may need to apply a large tractive force. As resistive forces increase with velocity, at some given rate of movement the tractive effort will equal the resistive forces and the locomotive will not be able to accelerate further, which may limit a locomotive's top speed.

Further, if the tractive force exceeds the adhesion the wheels will slip on the rail. Increasing adhesion, then, can increase the amount of tractive force that can be applied by the locomotive. The level of adhesion, however, is ultimately limited by the capacity of the system hardware. Because adhesion may be at least partially dependent on the frictional conditions between the steel wheel of the locomotive and the steel rail, inclement weather, debris and operating conditions such as travel around corners can lower the adhesion available and exacerbate traction problems.

Even with optimal conditions, however, metal wheels on the metal track may have insufficient traction for a task at hand, especially when hauling heavy loads. In addition, the surfaces, i.e., the rail and the wheels, may be smooth and the actual contact patch between a rail and a wheel can be very small. Accordingly, poor traction can make it difficult for a locomotive to haul heavy cargos and particular difficulty may arise during a start or up a grade. Operation of the vehicle above the maximum tractive effort is problematic, and is sometime referred to as being adhesion limited.

Inadequate traction may cause wheel noise and rail wear. Moreover, slipping wheels cause wear to the track, the wheels, and to the entire train. In particular, as wheels slip, they may damage the track and be burnished and abraded by the track. The wheels can go out of round and/or develop flat spots. This damage to the wheel and rail may cause vibrations, damage transported goods, and wear on train suspension. Wear to the track also causes vibrations and wear. In connection with this, wear patterns on a rail surface can result in high frequency vibrations and audible noise.

Currently, sand may be applied to the interface of the drive wheels of the locomotive with the rail surface to increase traction. This method, however, provides only temporary extra traction, as some or all of the applied sand on the rail falls off after the passage of one wheel set. Of note is that the angle of the sander nozzle aims to direct sand directly to the wheel/rail interface to increase the amount of sand present and available to provide traction.

It may be desirable to have a system and method that differs from those currently available with properties and characteristics that differ from those properties of currently available systems and methods.

Moreover, it is important to maintain the railroad track and its components, e.g., fasteners and rail segments, as the condition of the track can affect the reliability of rail transportation over the track. Maintenance often involves inspection of the track through the use of a rail vehicle equipped with an onboard sensor or sensors.

Railway inspection vehicles typically employ an array of sensors that measure multiple parameters for maintenance planning and regulatory purposes. In particular, optical sensors such as laser scanners, still cameras and video systems may be utilized. Such systems are used to measure parameters such as rail-to-rail gauge, rail head profile, catenary wire position and wear, track geometry, and clearances. As will be appreciated, the performance of such sensors depends, in part, on the cleanliness of the optical elements. The rail environment, however, is hostile to maintaining optical element cleanliness.

In particular, on board optical sensors may be exposed to dust and ballast rock “fines” that are raised by trains and crossing highway vehicles. Sensors may also be exposed to airborne contaminants from open railcars such as coal or ore dust, as well as ferrous dust from normal wear of the wheels, rail, and brake pads. Moreover, splashed rail lubricant and normal meteorological contaminants can affect the cleanliness of on board optical sensors. As will be appreciated, these conditions may reduce the efficacy of the optical sensors and necessitate cleaning the sensors, which requires ceasing operation of the rail vehicle hosting the optical sensor.

It may be desirable to have a system and method for cleaning board optical sensors without ceasing vehicle operation and that facilitates high quality, accurate track inspection.

### BRIEF DESCRIPTION

In an embodiment, a system for use with a vehicle includes at least one nozzle and a reservoir capable of holding a volume of pressurized gas or other fluid. The reservoir is in fluid communication with the at least one nozzle and the at least one nozzle is selectively operable to direct the pressurized fluid at a surface of an optical inspection sensor assembly to remove contaminants from the sensor assembly.

In an embodiment, a system for use with a vehicle includes a nozzle configured to receive pressurized gas or other fluid from a reservoir and direct the pressurized gas or other fluid at an optical sensor assembly. The system further includes a second sensor configured to detect operational data and a controller in electrical communication with the second sensor for receiving the operational data therefrom, the controller being operable to change at least one of a flow rate, a pressure, a velocity, or an angle of incidence of the pressurized gas or other fluid in dependence upon the operational data.

In another embodiment, a system includes an array of nozzles, each nozzle having a respective body defining a passageway therethrough and having an inlet for accepting pressurized gas or other fluid and an outlet for directing pressurized gas or other fluid onto an optical inspection sensor assembly.

### BRIEF DESCRIPTION OF DRAWINGS

Reference will be made in detail to exemplary embodiments of the invention, examples of which are illustrated in the accompanying drawings. Wherever possible, the same reference numerals used throughout the drawings refer to the same or like parts.

FIG. 1 is a schematic drawing of an exemplary rail vehicle.

FIG. 2 is a schematic drawing of a tractive effort system according to an embodiment of the invention.

FIG. 3 is a schematic drawing of a tractive effort system in accordance with an embodiment of the invention.

FIG. 4 is a schematic drawing of a tractive effort system in accordance with an embodiment of the invention.

FIG. 5 is a schematic drawing of a tractive effort system in accordance with an embodiment of the invention.

FIG. 6 is a schematic drawing of a tractive effort system in accordance with an embodiment of the invention.

FIG. 7 is a graph illustrating tractive effort values achieved utilizing the tractive effort system of FIG. 3 under various operating conditions.

FIG. 8 is a detail perspective view of an anti-clogging nozzle, in accordance with an embodiment of the invention, for use with the tractive effort systems of FIGS. 2-6.

FIG. 9 is a detail view of the anti-clogging nozzle of FIG. 8 in an operating mode, in accordance with an embodiment of the invention.

FIG. 10 is a detail view of the anti-clogging nozzle of FIG. 8 in a cleaning mode, in accordance with an embodiment of the invention.

FIG. 11 is a perspective view of an anti-clogging nozzle, in accordance with an embodiment of the invention, in an unclogged state, for use with a tractive effort system.

FIG. 12 is a side, cross-sectional view of the anti-clogging nozzle of FIG. 11.

FIG. 13 is a perspective view of the anti-clogging nozzle of FIG. 11, in accordance with an embodiment of the present invention, in a clogged state.

FIG. 14 is a side, cross-sectional view of the anti-clogging nozzle of FIG. 13.

FIG. 15 is a side, cross-sectional view of an anti-clogging nozzle, in accordance with an embodiment of the invention, in an un-clogged state, for use with a tractive effort system.

FIG. 16 is a side, cross-sectional view of the anti-clogging nozzle of FIG. 15, in accordance with an embodiment of the invention, in a clogged state.

FIG. 17 is a perspective view of an anti-clogging nozzle, in accordance with an embodiment of the invention, in an un-clogged state, for use with a tractive effort system.

FIG. 18 is a partial, side cross-sectional view of the anti-clogging nozzle of FIG. 17.

FIG. 19 is a perspective view of the anti-clogging nozzle of FIG. 17, in accordance with an embodiment of the invention, in a clogged state.

FIG. 20 is a partial, side cross-sectional view of the anti-clogging nozzle of FIG. 19.

FIG. 21 is a perspective view of an anti-clogging nozzle, in accordance with an embodiment of the invention, in an un-clogged state, for use with a tractive effort system.

FIG. 22 is a partial, side cross-sectional view of the anti-clogging nozzle of FIG. 21.

FIG. 23 is a perspective view of an anti-clogging nozzle of FIG. 21, in accordance with an embodiment of the invention, in a clogged state.

FIG. 24 is a partial, side cross-sectional view of the anti-clogging nozzle of FIG. 23.

FIG. 25 is a schematic drawing of a portion of a tractive effort system illustrating the position of a nozzle on a journal box of a vehicle, as viewed from the front of a vehicle, in accordance with an embodiment of the invention.

FIG. 26 is a schematic drawing of an automatic nozzle directional alignment system in accordance with an embodiment of the invention, for use with a tractive effort system.

FIG. 27 is a schematic drawing of a system for maintaining sensor performance in accordance with an embodiment of the present invention.

FIG. 28 is a schematic drawing of a portion of a system for maintaining sensor performance illustrating a configuration of nozzles about a sensor according to an embodiment of the present invention.

FIG. 29 is a schematic drawing of a portion of a system for maintaining sensor performance illustrating a configuration of nozzles about a sensor according to another embodiment of the present invention.

FIG. 30 is a schematic drawing of a portion of a system for maintaining sensor performance illustrating a configuration of nozzles about a sensor according to another embodiment of the present invention.

FIG. 31 is a schematic perspective view of a portion of a system for maintaining sensor performance illustrating a configuration of nozzles in accordance with an embodiment of the present invention.

### DETAILED DESCRIPTION

Embodiments of the invention relate to a tractive effort system for modifying the traction of a wheel contacting a surface, and associated methods.

As used herein, “contact surface” means the area of contact on a surface that both is where a nozzle directs a stream of tractive material and where a portion of the surface will meet a wheel that is rolling over the surface; it is distinguished from the wheel/surface interface that, at any point in time, is where the wheel is actually contacting the surface. In exemplary instances, a surface can be a metal rail or pavement, and the wheel can be a metal wheel or a polymeric wheel. “Rail vehicle” can be a locomotive, switcher, shunter, and the like and includes both freight haulage and passenger locomotives, which themselves may be diesel electric or all electric, and that may run on either AC or DC electric power. “Debris” may mean leaves and vegitation, water, snow, ash, oil, grease, insect swarms, and other materials that can coat a rail surface and adversely affect performance. The terms “rail” and “track” may be used interchangeably throughout, and where practical include pathways and roads. Although discussed in more detail elsewhere herein, the term “tractive material” can include abrasive particulate matter as well as a flow of air, as such an air-only stream is defined. Context and explicit language may be used to identify and differentiate those applications that refer air plus abrasive or to air-only instances, but in the absence of a reference to abrasive particulate an air-only stream is intended, and with certain embodiments the option to selectively add particulate to the otherwise air-only stream. As used herein, the expression “fluidly coupled” or “fluid communication” refers to an arrangement of two or more features such that the features are connected in such a way as to permit the flow of fluid between the features and permits fluid transfer.

As used herein, “impact” means imparting a force greater than a force that would be imparted if the tractive material were applied to the contact surface under force of gravity only. For example, in an embodiment, the tractive material is ejected from the nozzle as a pressurized stream, i.e., the velocity of the tractive material exiting the nozzle is greater than the velocity of the tractive material if applied to the contact surface by gravity only. As used herein, “roughness” is a measure of a profile roughness parameter of a surface. For purposes of illustration a rail implementation is provided in detail in which a locomotive with flanged steel wheels rides on a pair of steel tracks.

Embodiments of the invention further relate to a system and method for maintaining sensor performance and, in particular, maintaining the performance of optical sensors that measure multiple parameters for maintenance planning and regulatory purposes. As used herein, “optical sensors” refers to sensors that employ optics including, but not limited to, laser scanners, still cameras, and video systems. The term “contaminants” refers to dust, ballast rock fines, coal and ore dust, ferrous dust, splashed lubricant, normal environmental contaminants and the like that may affect performance of an optical sensor.

Embodiments of the invention that relate to a tractive effort system for modifying the traction of a wheel contacting a rail or track include a reservoir, in the form of a tank, capable of holding a tractive material and a nozzle coupled to the reservoir and in fluid communication therewith. The nozzle receives the tractive material from the reservoir and directs at least a portion of the tractive material to a contact surface of the rail prior to the contact surface being contacted by the wheel. The directed tractive material impacts the contact surface for modifying the traction of the wheel contacting the rail. That is, when the tractive material impacts the rail, it removes or clears debris from the rail allowing for more direct contact between the rail and the wheel. In addition, the tractive material may alter the contact surface of the rail to, for example, roughen smooth spots or to even out wear patterns that have formed in or on the rail. Moreover, the tractive material may both remove debris and alter the surface morphology of the rail upon impact.

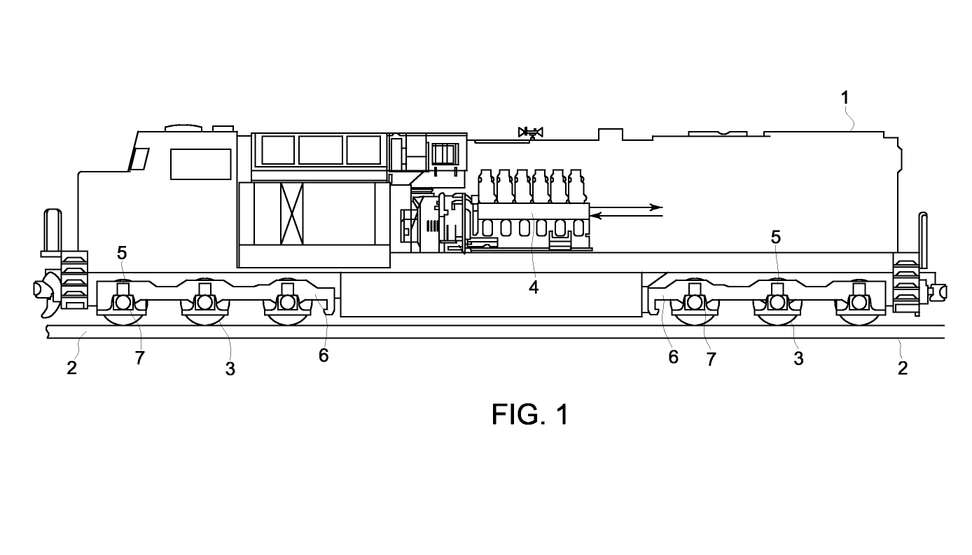

In some embodiments, the tractive effort system may be configured for use in connection with a vehicle, such as a rail vehicle or locomotive. For example, FIG. 1 shows a schematic diagram of a vehicle, herein depicted as a rail vehicle 1, configured to run on a rail 2 via a plurality of wheels 3. As depicted, the rail vehicle 1 includes an engine 4, such as an internal combustion engine. A plurality of traction motors 5 are mounted on a truck frame 6, and are each connected to one of a plurality of wheels 3 to provide tractive power to propel and retard the motion of the rail vehicle 1. A journal box 7 may be coupled to truck frame 6 at one or more of the wheels 3. The traction motors 5 may receive electrical power from a generator to provide tractive power to the rail vehicle 1.

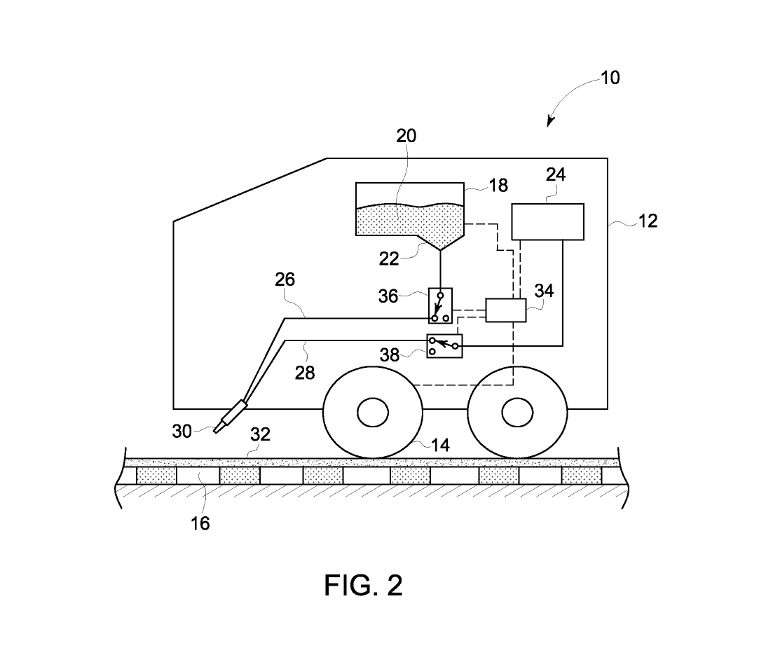

A schematic diagram illustrating a tractive effort system 10 including an embodiment of the invention is shown in FIG. 2. In the illustrated embodiment, the system is deployed on a rail vehicle 12 that has at least one wheel 14 for traveling over a rail 16. As shown therein, the tractive effort system includes an abrasive reservoir/tractive media reservoir 18, in the form of a tank, capable of holding a volume of tractive material 20 and having a funnel 22 from which the tractive material 20 may be dispensed. In an embodiment, the reservoir is unpressurized. The system also includes an air reservoir 24 containing a supply of pressurized air. The air reservoir 24 may be a main reservoir equalization tank that enables the function of numerous operational components of the vehicle, such as air brakes and the like. In another embodiment, the air reservoir 24 may be a dedicated air reservoir for the tractive effort system 10. An abrasive conduit 26 and an air supply conduit 28 carry the tractive material from the abrasive reservoir and pressurized air from the air reservoir, respectively, to a nozzle 30, at which the tractive material is entrained in the pressurized air stream to accelerate the tractive material onto a contact surface 32 of the rail. The tractive material impacts the contact surface at speed and removes any debris present and/or increases the surface roughness of the rail (i.e., the contact surface), as discussed in detail below.

As further shown therein, the system further includes a controller 34 that controls the supply of tractive material and/or the pressurized air from the air reservoir 24. In an embodiment, pressurized air alone may be discharged from the nozzle. In connection with the controller, the system may also include a media valve 36 and an air valve 38. The media valve 36 is in fluid communication with the output of the funnel 22 of the reservoir 18 and is controllable between a first state or position in which the tractive material may flow to the nozzle (as shown in FIG. 2), and a second state or position in which the tractive material cannot flow to the nozzle. The first and second states may be open and closed states, respectively.

The air valve 38 is in fluid communication with the air reservoir. In an embodiment, the air reservoir is a vessel that contains pressurized air (e.g., it may be the storage tank of an air compressor). In an embodiment, the air reservoir may be an existing component/system of the vehicle 12, such as a main reservoir equalization tank (MRE). As with the media valve 36, the air valve 38 is controllable between a first state or position in which pressurized air may flow to the nozzle (as shown in FIG. 2), and a second state or position in which the pressurized air cannot flow to the nozzle. The first and second states may be open and closed states, respectively. As shown in FIG. 2, the controller is electrically or otherwise operably coupled to the media valve 36 and the air valve 38 for controlling the media valve 36 and the air valve 38 between their respective first and second states.

For applying the tractive material to the contact surface, the controller controls the media valve and the air valve to their first (i.e., open) states. For applying air only, the controller controls the media valve to its second state (i.e., closed) and the air valve to its first state (e.g., open). For an “off” condition, the controller controls the media valve and the air valve to their second (i.e., closed) states.

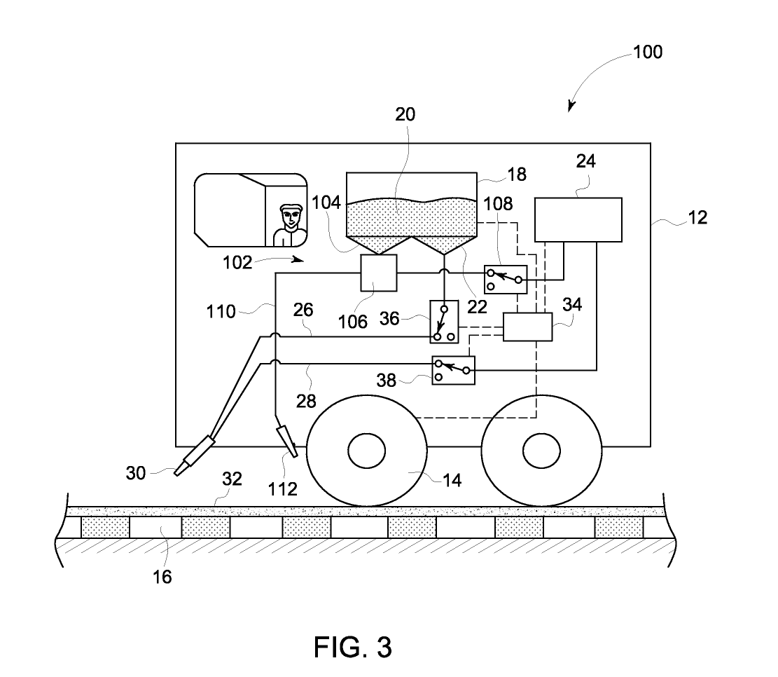

FIG. 3 is a schematic diagram illustrating a tractive effort system in accordance with an embodiment of the invention. The system 100 shown in FIG. 3 is deployed on a locomotive (as a proxy for general vehicle types) that has a wheel for traveling over a rail. As shown therein, the tractive effort system includes a reservoir 18, in the form of a tank, capable of holding a volume of tractive material and having a first funnel 22 from which the tractive material is dispensed. The reservoir may be referred to as an abrasive reservoir to distinguish it from an air reservoir or some other reservoir. In one embodiment, the abrasive reservoir is unpressurized. The system also includes an air reservoir containing a supply of pressurized air. An abrasive conduit 26 and air supply conduit 28 carry the tractive material from the reservoir 18 and pressurized air from the air reservoir, respectively, to a nozzle, at which the tractive material 110 is entrained in the pressurized air stream to accelerate the tractive material onto the contact surface of the rail. As with the system of FIG. 2, the tractive material impacts the contact surface at speed and removes any debris present and/or increases the surface roughness of the rail (i.e., the contact surface).

As further shown therein, the system includes a controller that controls the amount, flow rate, pressure, type, and quantity of the supply of tractive material and/or the pressurized air from the air reservoir. In an embodiment, pressurized air alone may be discharged from the nozzle. In connection with the controller, the system 100 may also include a media valve 36 and an air valve 38. The media valve 36 is in fluid communication with the output of the funnel 22 of the reservoir 18 and is controllable between a first state or position in which the tractive material may flow to the nozzle (as shown in FIG. 3), and a second state or position in which the tractive material cannot flow to the nozzle. The first and second states may be open and closed states, respectively.

The air valve is in fluid communication with the air reservoir. In an embodiment, the air reservoir is a vessel that contains pressurized air (e.g., it may be the storage tank of an air compressor). In an embodiment, the air reservoir may be an existing component/system of the vehicle. As with the media valve, the air valve 38 is controllable between a first state or position in which pressurized air may flow to the nozzle (as shown in FIG. 3), and a second state or position in which the pressurized air cannot flow to the nozzle. The first and second states may be open and closed states, respectively. As shown in FIG. 3, the controller is electrically or otherwise operably coupled to the media valve and the air valve 38 for controlling the media valve and the air valve between their respective first and second states.

For applying the tractive material to the contact surface, the controller controls the media valve and the air valve to their first (i.e., open) states. For applying air only, the controller controls the media valve to its second state (i.e., closed) and the air valve to its first state (e.g., open). For an “off” condition, the controller controls the media valve and the air valve to their second (i.e., closed) states.

As further shown in FIG. 3, the tractive effort system also includes a sanding system 102. In an embodiment, the sanding system 102 utilizes the same reservoir 18 as a supply of tractive material, although separate tanks or reservoirs may be utilized without departing from the broader aspects of the invention. In the embodiment where a single reservoir 18 is employed, the reservoir includes a second funnel 104 from which the tractive material is dispensed. As shown in FIG. 3, the sanding system 102 includes a sand trap 106 in fluid communication with an output of the funnel 104 and in fluid communication with the pressurized air reservoir. A supply of pressurized air from the air reservoir to the sand trap 106 is regulated by a sander air valve 108. The sand trap 106 is in fluid communication, via a sanding conduit 110, with a sanding dispenser 112 (or “sander”). The sanding dispenser is oriented to provide a layer of sand onto the rail surface so that there is a layer of sand at the wheel/rail interface to enhance traction.

As with the media valve and air valve, the sander air valve 108 is controllable between a first state or position in which pressurized air may flow to the nozzle sand trap 106 (as shown in FIG. 3), and a second state or position in which the pressurized air cannot flow to the sand trap 106. The first and second states may be open and closed states, respectively. During one mode of operation, a layer of sand from the sander is directed to the wheel interface under conditions that allow for at least some of the sand to remain at the wheel interface. The dispensing of the layer of sand occurs after impacting the contact surface with the flow of tractive material. In this manner the sand is not blown away by the flow of tractive material having a flow rate or velocity that is otherwise sufficiently high to blow away any sand or particulate tractive material that may be used.

As shown in FIG. 3, the controller is electrically or otherwise operably coupled to the sander air valve 108 for controlling the valve 108 between its respective first and second states. A layer of sand from the media reservoir at the wheel interface through a sand dispenser under conditions that allow for at least some of the sand to remain at the wheel interface, and the dispensing of the layer of sand occurs after impacting the contact surface with the flow of tractive material, whereby the sand is not blown away by the flow of tractive material having a flow rate or velocity that is sufficiently high to blow away particulate tractive material.

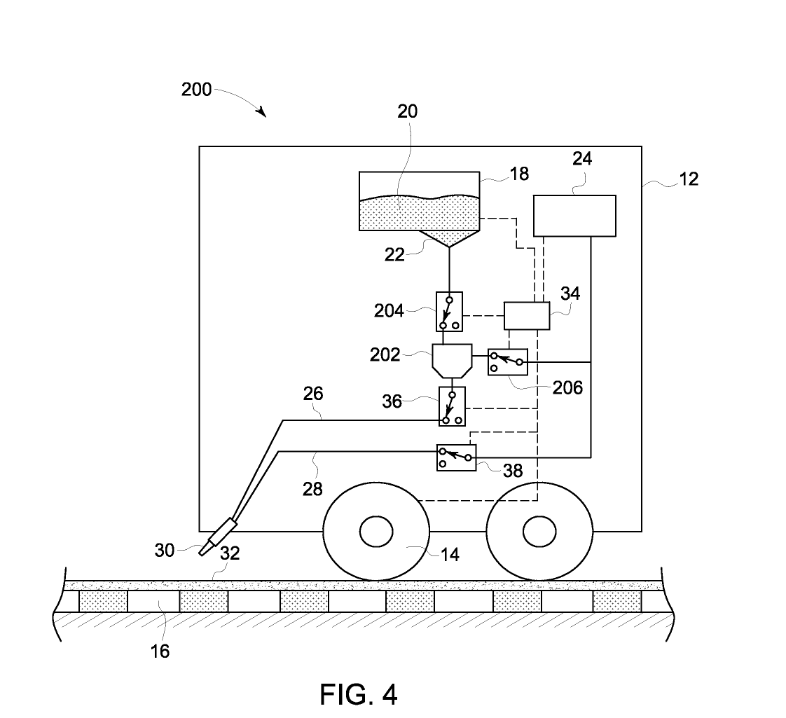

With reference to FIG. 4, a schematic drawing of a tractive effort system 200 according to an embodiment of the invention is shown. The system 200 includes a pressurizable pressure vessel 202 that is fed tractive material from the unpressurized reservoir 18. For this purpose, the system 200 further comprises a batch valve 204 and a second air valve 206. The batch valve 204 is similar to the media valve, that is, it is controllable by the controller between first and second states for permitting the passage of tractive material.

As shown in FIG. 4, an input of the batch valve 204 is fluidly coupled to the output of the first funnel 22 of the reservoir 18, and an output of the batch valve 204 is fluidly coupled to the input of the pressure vessel 202. The input of the media valve is fluidly coupled to the output of the pressure vessel 202, between the pressure vessel and the nozzle. The second air valve 206 is fluidly coupled between the air reservoir and a pressure input of the pressure vessel 202. The second air valve 206 is electrically coupled to and controllable by the controller 24 between first and second states (i.e., open and closed states, respectively), wherein in the first state pressurized air is supplied to the pressure vessel 202 and in the second state no pressurized air is supplied to the pressure vessel 202.

In operation, for applying air only to the contact surface of the rail, the controller controls the media valve to its second state (i.e., closed) and the first air valve to its first state (i.e., open). For filing the pressure vessel 202 with tractive material, the controller controls the media valve to its second state (i.e., closed), the second air valve 206 to its second state (i.e., closed), and the batch valve 204 to its first state (i.e., open). The batch valve 204 may be controlled to allow a sufficient volume of tractive material to fill the pressure vessel 202, based on time or volumetric flow or fill level sensors, or the batch valve 204 may be configured to be controllable to the second state (i.e., closed) despite the presence of tractive material within the batch valve 204.

For applying the tractive material to the contact surface, the controller controls the batch valve 204 to its second state (i.e., closed), the air valve to its second state (i.e., closed), and the media valve and the second air valve 206 to their respective first states (i.e., open). With the batch valve 204 and first air valve closed and the media valve and second air valve 206 open, the tractive material in the pressure vessel flows through the line and out of the nozzle. The tractive material impacts the contact surface at speed and removes any debris present and/or increases the surface roughness of the rail (i.e., the contact surface), as discussed hereinafter.

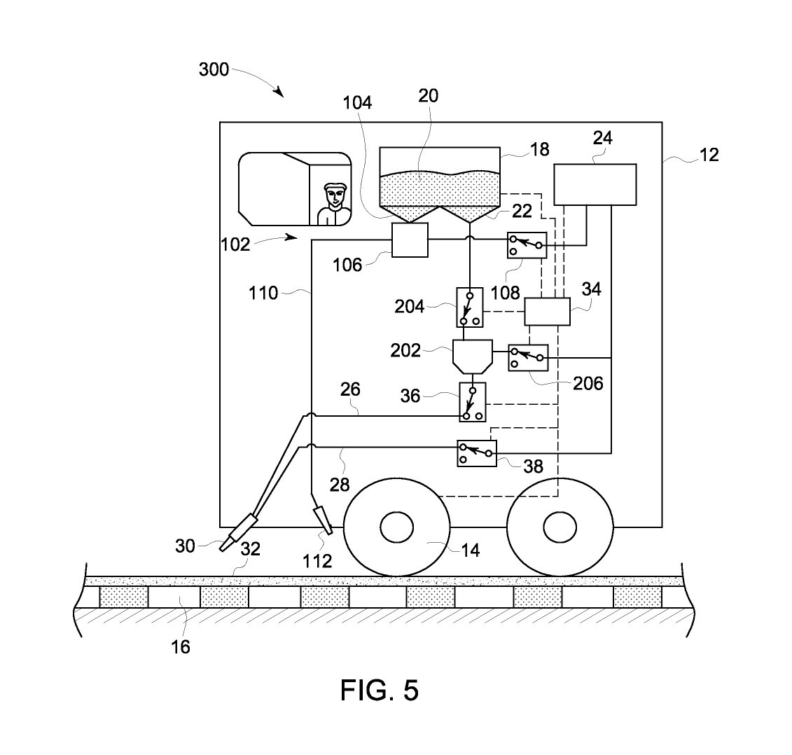

Turning now to FIG. 5, a tractive effort system 300 according to an embodiment of the invention is shown. As depicted, the system 300 includes a sanding system 102, as disclosed above in connection with the system 100 shown in FIG. 2. As shown in FIG. 5, the system 300 includes a pressurizable pressure vessel 202 that is fed tractive material from the unpressurized media reservoir. The system 200 further includes a batch valve 204 and a second air valve 206. As shown therein, an input of the batch valve 204 is fluidly coupled to the output of the first funnel 22 of the reservoir 18, and an output of the batch valve 204 is fluidly coupled to the input of the pressure vessel 202. The input of the media valve is fluidly coupled to the output of the pressure vessel 202, between the pressure vessel and the nozzle. The second air valve 206 is fluidly coupled between the air reservoir and a pressure input of the pressure vessel 202. The second air valve 206 is electrically coupled to and controllable by the controller between first and second states (i.e., open and closed states, respectively), wherein in the first state pressurized air is supplied to the pressure vessel 202 and in the second state no pressurized air is supplied to the pressure vessel 202.

In operation of a system that can provide traction material with particulate, for applying air only to the contact surface of the rail, the controller controls a valve for particulate flow (e.g., media valve) to its second state (i.e., closed) and the first air valve to its first state (i.e., open). For filing the pressure vessel 202 with tractive material, the controller controls the media valve to its second state (i.e., closed), the second air valve 206 to its second state (i.e., closed), and the batch valve 204 to its first state (i.e., open). The batch valve 204 may be controlled to allow a sufficient volume of tractive material to fill the pressure vessel 202, based on time or volumetric flow or fill level sensors, or the batch valve 204 may be configured to be controllable to the second state (i.e., closed) despite the presence of tractive material within the batch valve 204.

For applying the tractive material to the contact surface, the controller controls the batch valve 204 to its second state (i.e., closed), the air valve to its second state (i.e., closed), and the media valve and the second air valve 206 to their respective first states (i.e., open). With the batch valve 204 and first air valve closed and the media valve and second air valve 206 open, the tractive material in the pressure vessel flows through line 26, out of the nozzle. The tractive material impacts the contact surface at speed and removes any debris present and/or increases the surface roughness of the rail (i.e., the contact surface), as discussed hereinafter.

As noted above, the system 300 further includes a sanding system 102. As discussed above in connection with FIG. 3, the sanding system 102 utilizes the same reservoir 18 as a supply of tractive material, although separate tanks or reservoirs may be utilized without departing from the broader aspects of the invention. In the embodiment where a single reservoir 18 is employed, the reservoir 18 includes a second funnel 104 from which the tractive material is dispensed. As shown in FIG. 3, the sanding system 102 includes a sand trap 106 in fluid communication with an output of the funnel 104 and in fluid communication with the pressurized air reservoir. A supply of pressurized air from the air reservoir to the sand trap 106 is regulated by a sander air valve 108. The sand trap 106 is in fluid communication, via a sanding conduit 110, with a sanding dispenser 112. The sanding dispenser 112 is oriented to provide a layer of tractive material onto the rail surface just ahead of the wheel such that the wheel and rail receive a layer of tractive material therebetween, to enhance traction.

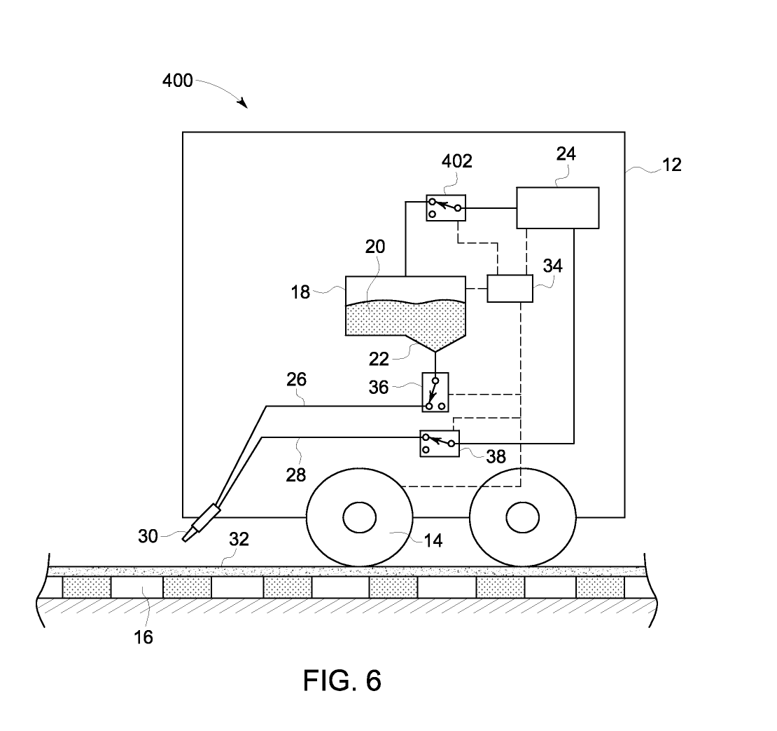

With reference to FIG. 6, a schematic drawing of a tractive effort system 400 according to another embodiment of the invention is shown. As depicted, the system 400 includes an abrasive reservoir 18, in the form of a tank, capable of holding a volume of tractive material and having a funnel 22 from which the tractive material is dispensed. The system 10 also includes an air reservoir containing a supply of pressurized air. An abrasive conduit 26 and air supply conduit 28 carry the tractive material from the abrasive reservoir 18 and pressurized air from the air reservoir, respectively, to a nozzle, at which the tractive material is entrained in the pressurized air stream to accelerate the tractive material onto a contact surface of the rail.

In contrast to the system 10 of FIG. 2, the reservoir 18 of the system 400 is pressurized, as controlled through a pressurizing air valve 402, an input of which is in fluid communication with the air reservoir and an output of which is in fluid communication with tractive material reservoir 18.

The system 400 further includes a controller that controls the supply of tractive material and air 24. In an embodiment, pressurized air alone may be discharged from the nozzle. In connection with the controller, the system 10 may also include a media valve 36 and an air valve 38. The media valve is in fluid communication with the output of the funnel 22 of the reservoir 18 and is controllable between a first state or position in which the tractive material may flow to the nozzle (as shown in FIG. 6), and a second state or position in which the tractive material cannot flow to the nozzle. The first and second states may be open and closed states, respectively.

The air valve is in fluid communication with the air reservoir. In an embodiment, the air reservoir is a vessel that contains pressurized air (e.g., it may be the storage tank of an air compressor). In an embodiment, the air reservoir may be an existing component/system of the vehicle 12. As with the media valve and pressurizing air valve 502, the air valve is controllable between a first state or position in which pressurized air may flow to the nozzle, and a second state or position in which the pressurized air cannot flow to the nozzle. The first and second states may be open and closed states, respectively. As shown in FIG. 6, the controller is electrically or otherwise operably coupled to the media valve and the air valve for controlling the media valve and the air valve between their respective first and second states.

For applying the tractive material to the contact surface, the controller controls the pressurizing air valve 502, media valve and the air valve to their first (i.e., open) states such that tractive material is permitted to flow through line 26 to the nozzle. The tractive material is ejected from the nozzle and impacts the contact surface at speed and removes any debris present and/or increases the surface roughness of the rail (i.e., the contact surface), as discussed in detail below.

For applying air only, the controller controls the media valve to its second state (i.e., closed) and the air valve to its first state (e.g., open). For an “off” condition, the controller controls the media valve and the air valve to their second (i.e., closed) states.

As alluded to above, operation of the systems 10, 100, 200, 300, 400 in an abrasive deposition mode, in which tractive material is ejected from the nozzle and impacts the contact surface of the rail, increases the tractive effort of the vehicle or locomotive with which the system 10, 100, 200, 300 or 400 is employed. In such embodiments, the tractive material impacts the contact surface at speed and removes any debris present and/or increases the surface roughness of the rail (i.e., the contact surface).

In embodiments where the contact surface is modified by impacting tractive material, the modified roughness may be less than 0.1 micrometer (e.g., peaks with a height less than 0.1 micrometer), in a range of from about 0.1 micrometer to about 1 micrometer (e.g., peaks with a height from about 0.1 micrometer to about 1 micrometer), from about 1 micrometer to about 10 micrometers (e.g., peaks with a height from about 1 micrometer to about 10 micrometers), from about 10 micrometers to 1 millimeter (e.g., peaks with a height from about 10 micrometers to 1 millimeter), from about 1 millimeter to about 10 millimeters (e.g., peaks with a height from about 1 millimeter to about 10 millimeters), or greater than about 10 millimeters (e.g., peaks with a height greater than about 10 millimeters). In an embodiment, the modified morphology has peaks with a height that is greater than about 0.1 micrometer and less than 10 millimeters. According to one aspect, indicated peak heights are a maximum peak height.

In connection with the embodiments disclosed above, numerous operating parameters or characteristics of the systems 10, 100, 200, 300, 400 may be varied to produce a desired surface roughness. Such factors may include the type of tractive material utilized, the velocity of the tractive material exiting the nozzle, the quantity or flow rate of the tractive material, the type of rail, the speed of the vehicle 12, the distance of the nozzle from the contact surface, and other factors which may play a part in the resulting surface treatment. In various embodiments, the tractive material does not embed in the contact surface and/or the tractive material is substantially less hard than the rail track 16 and is incapable of being so embedded.

The degree that debris is removed from the track 16, and the degree to which the contact surface is modified, may affect the resultant level of observed tractive effort. In an embodiment, the tractive effort increases by an amount that is more than any one of water jetting the contact surface, scrubbing the contact surface, embedding particles into the contact surface, or laying loose sand particles over the contact surface. The increase in tractive effort may be 40,000 or more as a result of the application of the tractive material utilizing the systems 10, 100, 200, 300, 400 and method of the invention, e.g., tractive effort increases by a tractive effort value of at least 40,000 during application of the tractive material.

The tractive material may include particles that are harder than the track to be treated. Suitable types of harder particles include metal, ceramic, minerals, and alloys. A suitable hard metal can be tool grade steel, stainless steel, carbide steel, or a titanium alloy. Other suitable tractive materials may be formed from the bauxite group of minerals. Suitable bauxite material includes alumina (Al₂O₃) as a constituent, optionally with small amounts of titania (Ti₂O₃), iron oxide (Fe₂O₃), and silica (SiO₂) particles. In an embodiment, the alumina amount may constitute up to about 85 percent by weight or more of the mixture. Other suitable tractive materials can include crushed glass or glass beads. In other embodiments, the tractive material includes one or more particles formed from silica, alumina, or iron oxide. In an embodiment, other suitable tractive material can be an organic material. Suitable organic material can include particles formed from nutshells, such as walnut shells. Also of biologic origin, the tractive material can include particles formed from crustacean or seashells (such as skeletal remains of mollusks and similar sea creatures).

In one embodiment, the particles of the tractive material have a size in a range of from about 0.1 millimeters (mm) to about 2 mm. In other embodiments, the particle sizes of the tractive material may be in a range of from about 30 to about 100 standard mesh size, or from about 150 micrometers to about 600 micrometers. In an embodiment, the particles may have sharp edges or points. Particles with more than one sharp edge or point may be more likely to remove material or deform the rail track surface.

Additional suitable tractive materials include detergents, eutectics or salts, gels and cohesion modifiers, and dust reducers. All tractive materials can be used alone or in combination based on the application specific circumstances.

As noted above, with reference for example to FIG. 2, the systems 10, 100, 200, 300, 400 of the invention may be utilized onboard a vehicle 12 having a wheel 104 that is coupled to a powered axle of the vehicle 12. In an embodiment, the tractive effort system may be mounted on a vehicle that is part of a consist comprising a plurality of linked vehicles, where the wheel at issue (i.e., the wheel for which adhesion is to be increased) is mounted to a different vehicle in the consist. A situation might arise, where a consist is being used, where a first locomotive or other rail vehicle in the consist is not assigned a tractive effort system, but a second locomotive or later vehicle in the consist is equipped with a tractive effort system. In such cases, the slippage rate of the first locomotive can provide information to the controller about the travel conditions to tailor the tractive effort system's operations. In an embodiment, the tractive effort system may be mounted on the first locomotive to receive the entire tractive effort enhancement possible. It should be noted that in at least some circumstances the rail is a steel rail for use in transporting a rail vehicle. While FIGS. 2-6 shown the tractive effort system in connection with a locomotive, the system and method of the invention may be utilized on any rail vehicle, which is intended to encompass locomotives of all types, as well as switchers, shunters, slugs, and the like.

As disclosed above, the systems 10, 100, 200, 300, 400 may draw the tractive material (media) 20 from a media reservoir 18. In an embodiment, the reservoir 18 may be coupled to a heater, a vibrating device, a screen or filter, and/or a de-watering device.

In an embodiment, as shown in FIG. 6, for example, the reservoir tank 18 is pressurizable. In other embodiments, as shown in FIGS. 3 and 4, for example, tractive material is moved from a non-pressurized reservoir 18 to a pressure vessel 202, which is itself pressurizable. In either case, the pressure may be selected based on application specific parameters. Different embodiments may have correspondingly different air pressure requirements. In one embodiment, the air pressure may be greater than about 70 psi, but in other applications the operable pressure may be in a range of from about 75 psi to about 150 psi. During air-only operation (without the use of particulate in the fluid stream) in some instances the air pressure which might be sufficient for casting sand may not be sufficient to achieve a detectable increase in tractive effort. In one embodiment, the air-only mode of operation will use an air pressure that is greater than about 90 psi, or in a range of from about 90 psi to about 100 psi, from about 100 psi to about 110 psi, from about 110 psi to about 120 psi, from about 120 psi to about 130 psi, or from about 130 psi to about 140 psi.

In one embodiment on a locomotive, the air pressure is at the same pressure as the compressor supplied air used for the air brake reservoir at greater than about 100 psi or 689500 Pa (up to about ˜135 psi). With equalized pressure the system, may therefore be operated without the addition of an air pressure regulator. This may reduce cost, extend system life and reliability, increase the ease of manufacture and maintenance, and reduce or eliminate one or more failure modes. To further accommodate the relatively higher pressure applications, larger diameter piping may be employed than might be used with the relatively lower pressure (and possibly regulated) systems. The larger diameter piping may reduce the pressure drop experienced by the diameter downsized for a lower pressure and/or regulated system.

Air pressure is only one factor that may be considered in performance, other factors include air flow, air velocity, air temperature, ambient conditions, and operating parameters. With regard to air flow, the system may operate at flow rates of greater than 30 cubic feet per minute (CFM) for a pair of nozzles (each nozzle would have half of the value), or in a range of from about 30 CFM (about 0.85 cubic meters per minute) to about 75 CFM (about 2.12 cubic meters per minute), from about 75 CFM to about 100 CFM (about 2.83 cubic meters per minute), from about 100 CFM to about 110 CFM (about 3.11 cubic meters per minute), from about 110 CFM to about 120 CFM (about 3.40 cubic meters per minute), from about 120 CFM to about 130 CFM (about 3.68 cubic meters per minute), from about 130 CFM to about 140 CFM (about 3.96 cubic meters per minute), from about 140 CFM to about 150 CFM (about 4.25 cubic meters per minute), from about 150 CFM to about 160 CFM (about 4.53 cubic meters per minute), or greater than about 160 CFM for a nozzle pair. With regard to air velocity, the system may operate at an impact velocity of greater than 75 feet per second (FPS)(about 23 meters per second), or in a range of from about 75 FPS to about 100 FPS (about 30 meters per second), from about 100 FPS to about 200 FPS (about 61 meters per second), from about 200 FPS to about 300 FPS (about 91 meters per second), from about 300 FPS to about 400 FPS (about 122 meters per second), from about 400 FPS to about 450 FPS (about 137 meters per second), from about 450 FPS to about 500 FPS (about 152 meters per second), from about 500 FPS to about 550 FPS (about 168 meters per second), or greater than about 550 FPS.

In other embodiments, with regard to air flow, the system may operate at flow rates of greater than 0.85±0.05 cubic meters per minute for a pair of nozzles (each nozzle would have half of the value), or in a range of from 0.85±0.05 cubic meters per minute to 2.12±0.05 cubic meters per minute, from 2.12±0.05 cubic meters per minute to 2.83±0.05 cubic meters per minute, from about 2.83±0.05 cubic meters per minute to 3.11±0.05 cubic meters per minute, from 3.11±0.05 cubic meters per minute to 3.40±0.05 cubic meters per minute, from 3.40±0.05 cubic meters per minute to 3.68±0.05 cubic meters per minute, from 3.68±0.05 cubic meters per minute to 3.96±0.05 cubic meters per minute, from 3.96±0.05 cubic meters per minute to 4.25±0.05 cubic meters per minute, from 4.25±0.05 cubic meters per minute to 4.53±0.05 cubic meters per minute, or greater than 4.53±0.05 cubic meters per minute for a nozzle pair. With regard to air velocity, the system may operate at an impact velocity of greater than 23±1 meters per second, or in a range of from 23±1 meters per second to 30±1 meters per second, from 30±1 meters per second to 61±1 meters per second, from 61±1 meters per second to 91±1 meters per second, from 91±1 meters per second to 122±1 meters per second, from 122±1 meters per second to 137±1 meters per second, from 137±1 meters per second to 152 meters per second, from 152±1 meters per second to 168±1 meters per second, or greater than 168±1 meters per second.

An operational discussion is warranted at this point owing to the interaction of the air system of a locomotive with embodiments of the invention. One factor to consider is that a systemic loss of air pressure (or overall air volume) in an operating locomotive may “throw the safety brakes”. Locomotive air brakes disengage when the pressure in the air lines is above a threshold pressure level, and to brake the locomotive the air pressure in the line is reduced (thereby engaging the brakes and slowing the train). Drawing a large volume of air from the system for any purpose may cause a concomitant pressure drop. So, drawing air for the purpose of affecting tractive effort may cause a pressure drop. Another factor to consider is the operation of the compressor that supplies the air to the system. The compressor life may be adversely affected by cycling it on and off to maintain pressure in a determined range. Naturally, the method of operation of a system that consumes large amounts of air could affect the compressor operation. With those and other considerations in mind, the system can include a controller that accounts for these factors. In one embodiment, the controller is advised of the air pressure in and/or environmental conditions of the locomotive system and responds by controlling the air usage of the inventive system. For example, if the locomotive air reservoir (MRE) pressure drops below a threshold value the controller will reduce or eliminate the air flow of the inventive system until the MRE pressure is restored to a defined pressure level, or if there is a pressure trend change over time (such as may be due to a change in altitude of the locomotive) the controller may respond by making a correspond change in the use of the inventive system. The changes may be, of course, binary in nature such as just a simple switching off of the system entirely. However, there may be some benefit at a reduced flow rate for which the controller can adjust down the flow rate and see some reduced level of traction improvement. The controller optionally also may send a notice that the mode of operation has been changed in this manner, or may log the event, or may do nothing beyond making the change. Such notice may be decided based on implementation requirements.

During use, high-pressure air from the air reservoir may be applied to the abrasive reservoir or to the pressure vessel 202 where the air is mixed with tractive material. The media/air mixture may move toward the delivery nozzle where the mixture is accelerated by the nozzle. While the embodiments disclosed herein shown a single nozzle for distributing tractive material or an tractive material/air mixture, multiple nozzles 30 may be employed without departing from the broader aspects of the invention. The nozzle may serve a dual purpose of accelerating the tractive material/mixture as well as directing the material/mixture to the rail contact surface. In an embodiment, in addition to air, pressurized water or a gel may be utilized. In embodiments where a gel is used, it may be capable of leaving sufficient entrained tractive material as to increase adhesion by its presence in addition to the adhesion increase caused by debris removal and/or surface modification.

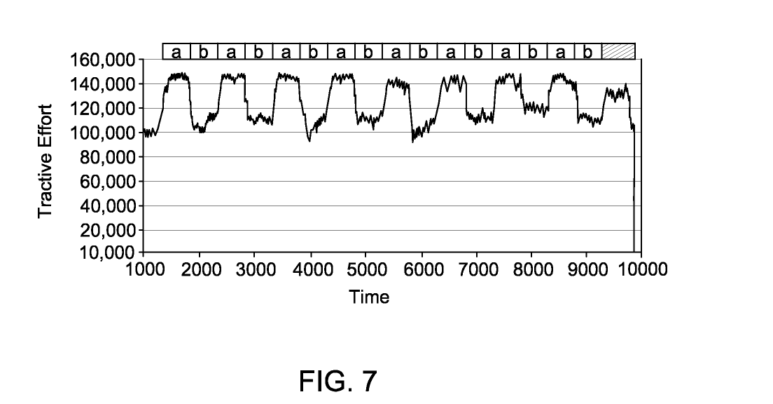

FIG. 7 is a graph illustrating tractive effort values achieved utilizing the tractive effort system of FIG. 3, with the sanding system 102 enabled, on a locomotive with five active axles on a wet rail over a period of time, at speeds of both 5 mph and 7 mph. The adhesion was measured, and the tractive effort system 200 was engaged and disengaged over time. In particular, intervals “a” represent the time periods when the tractive effort system is enabled, intervals “b” represent the time periods when the tractive effort system is disabled, and the black box indicates the time period when the tractive effort system may have only an air blast applied to the contact surface. As shown therein, results indicate that the wet rail adhesion increases in response to the impacting of the tractive material with the contact surface. As shown therein, adhesion is also increased when an air blast only is applied to the contact surface.

Here and elsewhere, the system is described in terms of one nozzle; however the inventive system can employ multiple nozzles that may operate independently or in a coordinated fashion under the direction of a controller. For lower pressure sources, the nozzle may be configured to create sufficient backpressure to accelerate the tractive material toward the contact surface during operation. In other embodiments, various attachments may be coupled to the nozzle. Suitable attachments may include, for example, vibrating devices, clog sensors, heaters, de-clogging devices, and the like. In one embodiment, a second nozzle may be present for supplying air, water, or a solution to the contact surface. The solution may be a solvent or may be a cleanser, such as a soap or detergent solution. Other solutions may include acidic solutions, metal passivation solutions (to preserve rail surfaces), and the like. Coupled to the nozzle may be a switch that stops the flow of tractive material while allowing a flow of air and/or water through the nozzle.

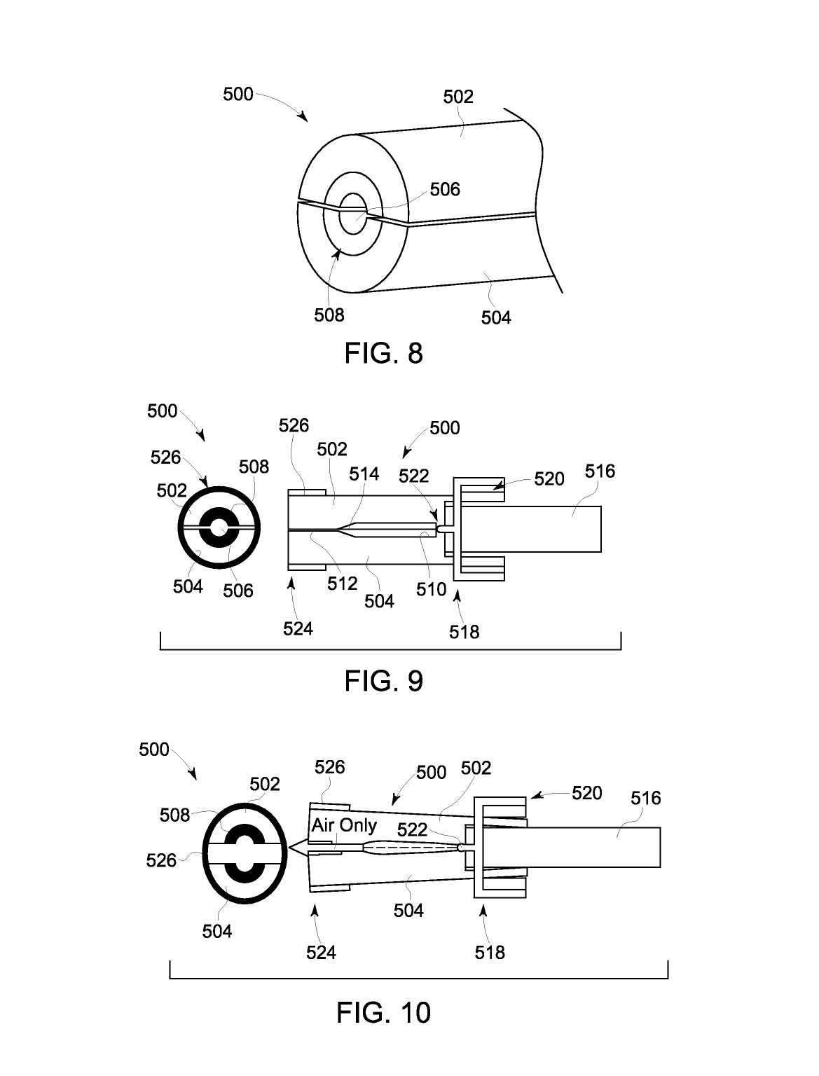

FIGS. 8-10 shown various detail views of a nozzle 500 according to an embodiment of the invention, suitable for use as nozzle in connection with the systems 10, 100, 200, 300, 400 disclosed above. As shown in FIG. 8, the nozzle 500 includes a first half 502 and a second half 504 that cooperate with each other to define a throughbore 506 through which the tractive material may pass. As best shown in FIG. 7, a hardened inner liner 508 is disposed or otherwise formed within the bore 506. In an embodiment, the liner 508 may be formed from a wear-resistant material such as a ceramic or cermet.

Referring now to FIG. 9, diagrammatic side and end views of the nozzle 500 in an operating mode are shown. As depicted, the throughbore 506 nozzle 500 has an enlarged diameter rearward portion 510, a reduced diameter forward portion 512 and a constriction portion 514 forming a transition between the rearward portion 510 and the forward portion 512. The constriction 514 accelerates the tractive material under urging by the pressurized air toward the contact surface (FIG. 2). Pressurized air and/or tractive material are supplied by an air/media hose 516, which is in fluid communication with the throughbore 506.

During certain operating conditions, however, and especially in damp conditions, tractive material may clog the nozzle, thereby decreasing the effectiveness of the system. In particular, in damp conditions, sand or other tractive material may clog the nozzle orifice. This may be due to tractive material particles having a size greater than the orifice diameter. In the case where sand is used as the tractive material, the sand may agglomerate, clump or freeze into chunks. In some instances this may be due to moisture content in the sand. The presence of such agglomerates blocking the nozzle and causing pressure to build up upstream of the nozzle orifice. Accordingly, at least some embodiments of the invention are directed to a nozzle design that facilitates clog-free operation.

In one embodiment, as shown in FIG. 10, the nozzle 500 (suitable for use as a nozzle in the system disclosed in FIG. 2) contains anti-clogging features. As best shown in the diagrammatic side and end views of the nozzle 500 in FIG. 9, the two halves 502, 504 of the nozzle 500 are attached at a near 518 end by an air bellows collar 520 and pivot/hinge 522. The nozzle halves 502, 504 separate at a distal end 524 thereof as the pivot/hinge 522 rotates, and a blast of air only from the air reservoir dislodges any clogs in the throughbore 506 of the nozzle 500. During the operating mode illustrated in FIG. 8, an elastic member 526 such as an elastic band, elastic sleeve, or the like, deployed about the outer/distal end of the nozzle 500, keeps the distal end of the first half 502 and second half 504 of the nozzle 500 together. During cleaning, or to prevent clogging, however, the bellows collar 520 stretches the elastic member 526 and allows the halves 502, 504 at the distal end of the nozzle 500 to separate upon receiving a blast of pressurized air from the air reservoir, or when pressure builds up upstream of the nozzle orifice and reaches a threshold pressure that causes the halves 502, 504 to separate.

In one embodiment, an anti-clogging nozzle utilizes an adjustment mechanism deployed in a body/orifice of the nozzle to clean or unclog the nozzle. A suitable adjustment mechanism may be a spring and plunger mechanism deployed in an orifice of the nozzle. Examples of suitable anti-clogging mechanisms are shown in FIGS. 11-22. Referring first to FIGS. 11-14, an embodiment of an anti-clogging nozzle 600 is shown. As depicted, tractive material is supplied to the nozzle outlet by a passageway 602. The nozzle includes a plunger 604 (see FIG. 11) that moves up and down by means of a spring, as the internal/upstream pressure within the nozzle 600 is varied.

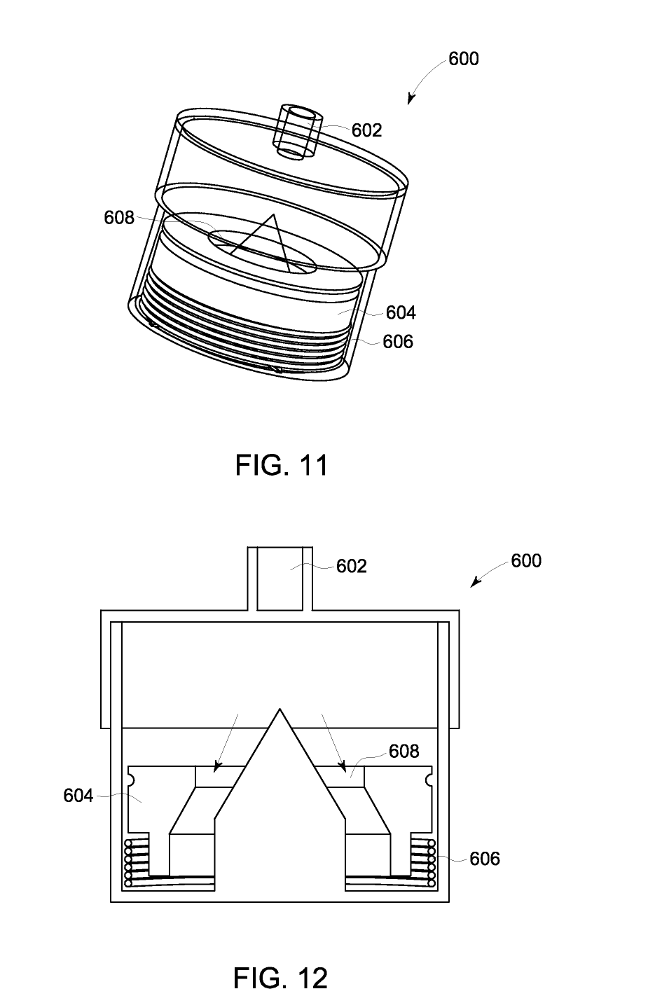

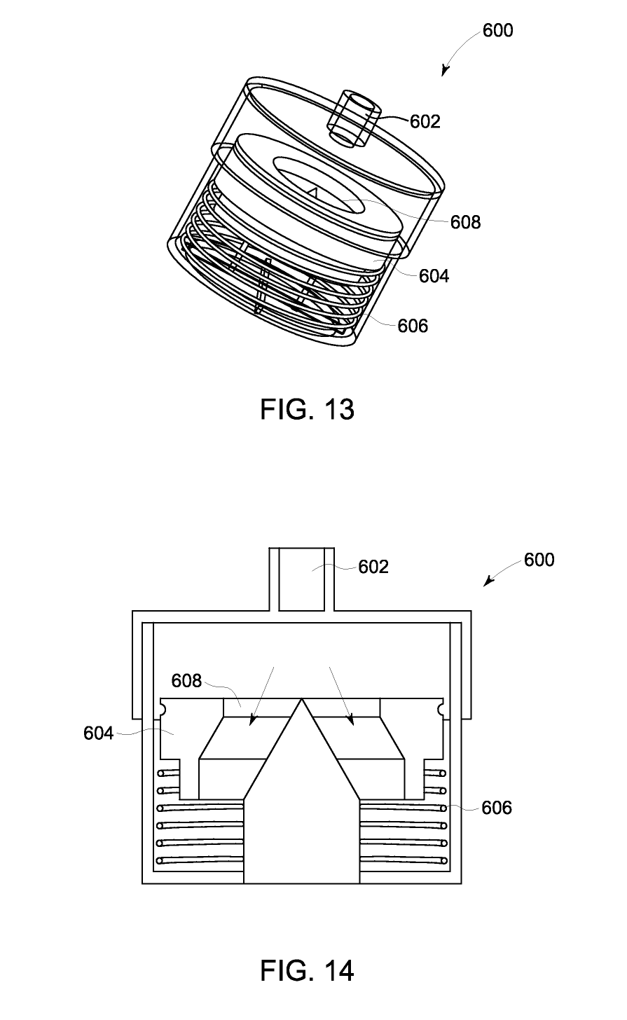

A plunger and spring position under normal operating conditions, i.e., when the nozzle is not clogged are illustrated in FIGS. 11 and 12. As shown therein, tractive material moves past the plunger through the passage and is ejected from the nozzle 600. When abrasive particles agglomerate the pressure upstream increases, clogging the nozzle. The pressure has to be therefore reduced periodically, either manually or using a controller to allow the spring 606 to relax and reach a position as shown in the FIGS. 13 and 14. This will increase the area of the passage 608 and allow the bigger particles to be dropped or pushed out. After the larger abrasive particles have been dispensed out of the nozzle and the nozzle is clear, the spring biases the plunger to its default position, as shown in FIGS. 11 and 12, decreasing the pass through area of the passage.

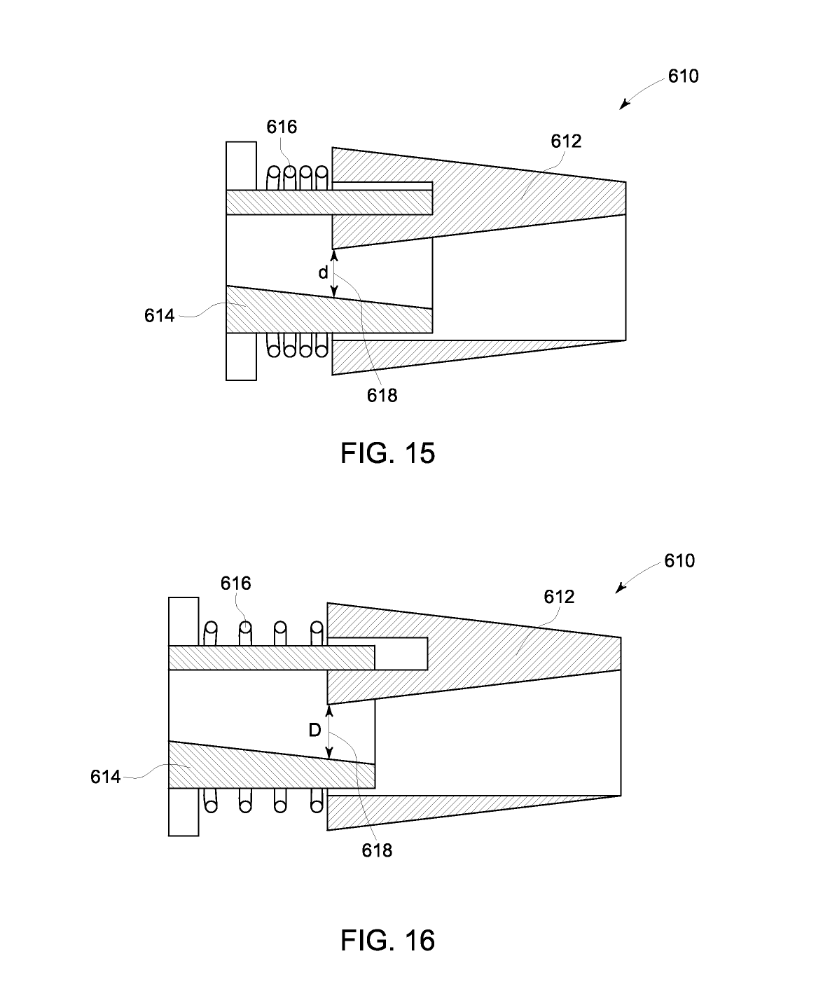

An anti-clogging nozzle 610 according to an embodiment of the invention is illustrated in FIGS. 15 and 16. As shown therein, the nozzle 610 includes a body or first portion 612 defining a passageway there through and a second portion 614 slidably received by said first portion 612 and having a conical passageway formed therein. A biasing member, such as a spring 616, is received about a periphery of the second portion 614. In an unclogged position, the second portion 614 is nested within the first position such that the diameter, d, and thus an area of a passageway 618 between the first portion 612 and second portion 614 is at a minimum. In this position the spring may have a relatively different level of tension and/o compression. When abrasive particles agglomerate, however, flow of tractive material out of the nozzle 610 may be at least partially blocked and back pressure may build within the first portion 612. As pressure builds, the second portion 614 is forced away from the first portion 612, extending the spring 616 in tension, as shown in FIG. 16. As the second portion 616 is moved outward, the diameter of the passageway 618 increases to a diameter, D, as further shown in FIG. 16. This increases the area of the passage 618, thus allowing bigger abrasive particles to clear the nozzle 610. After the larger abrasive particles have been dispensed out of the nozzle 610 and the nozzle 610 is clear, the spring 616 biases the second portion 614 to its default, non-clogged position, as shown in FIG. 15, decreasing the area of the passage 618.

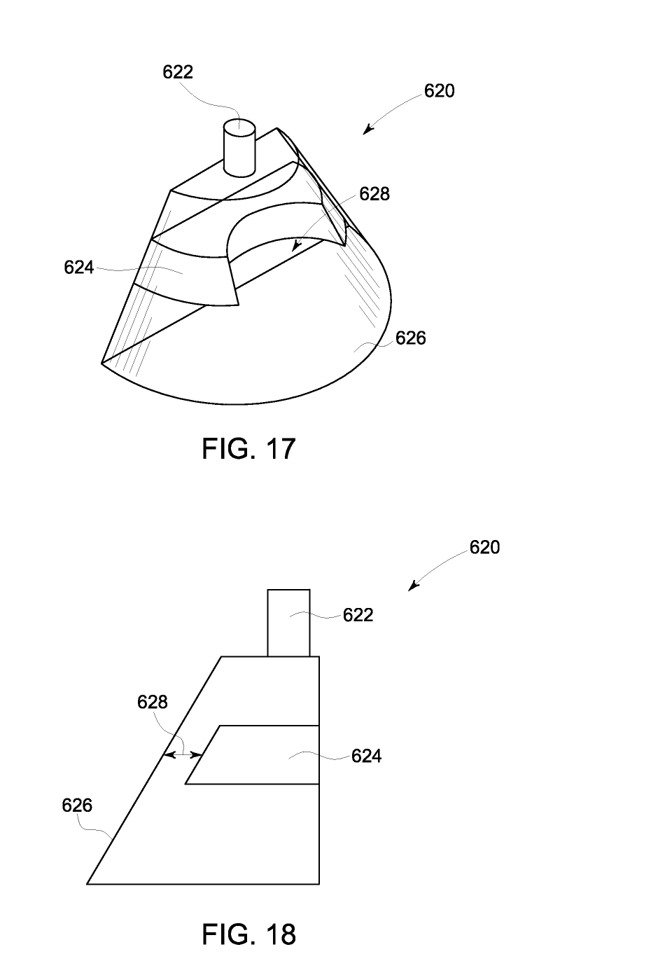

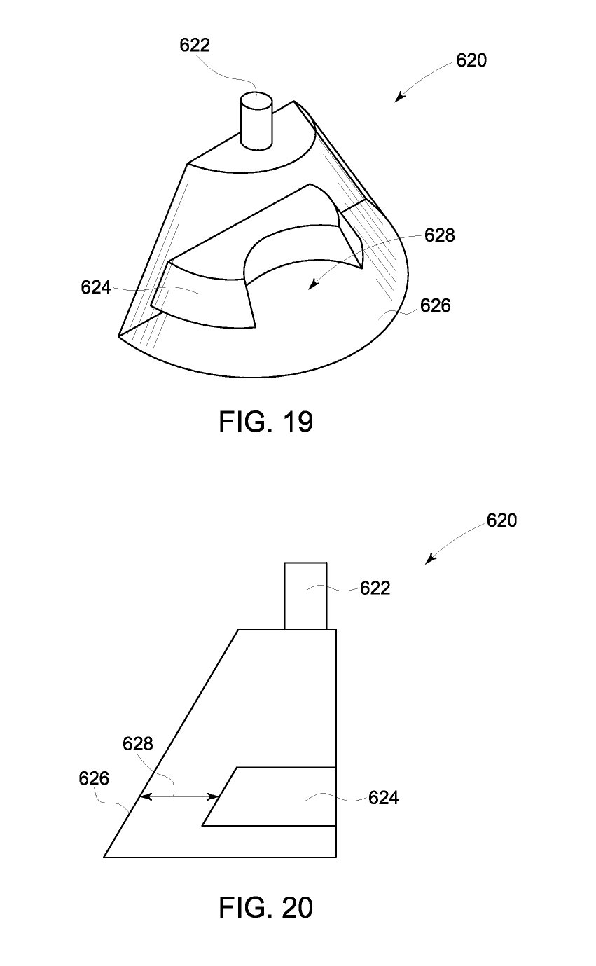

FIGS. 17-20 illustrate an anti-clogging nozzle 620 according to another embodiment of the invention. As shown therein, tractive material is supplied to the nozzle outlet by a passageway 622. The nozzle 620 includes a plunger 624 that moves up and down within the nozzle orifice 626 as the internal/upstream pressure within the nozzle 620 is varied. FIGS. 17 and 18 illustrate plunger 624 position under normal operating conditions, i.e., when the nozzle 620 is not clogged. As shown therein, tractive material moves past the plunger 624 between the plunger and a wall of the nozzle orifice 626 in which the plunger 624 is disposed. As shown in FIG. 18, the passageway 628 for passage of tractive material is relatively small when the nozzle 620 is in an unclogged state. When abrasive particles agglomerate, however, as discussed above, flow of tractive material out of the nozzle 620 is prevented and pressure builds upstream of the plunger 624. As pressure builds, the plunger 624 is forced downwards, to the position shown in FIGS. 19 and 20. As the plunger 624 is moved downwards, the space between the plunger and the wall of the orifice, i.e., the passageway 628, is increased, thus allowing bigger abrasive particles to clear the orifice and the nozzle 620. After the larger abrasive particles have been dispensed out of the nozzle 620 and the nozzle 620 is clear, the plunger 624 returns to the position shown in FIGS. 17 and 18.

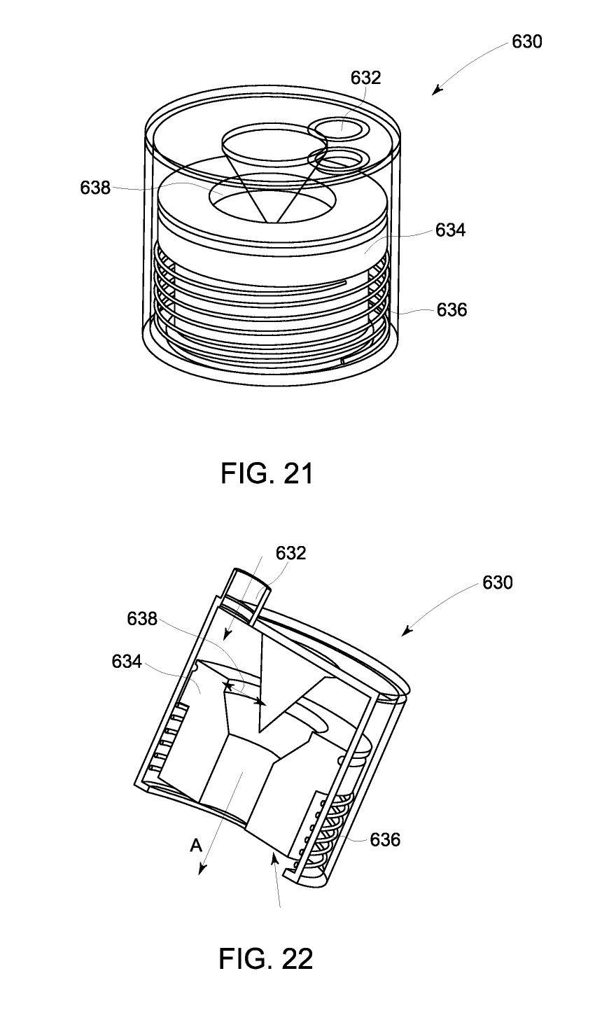

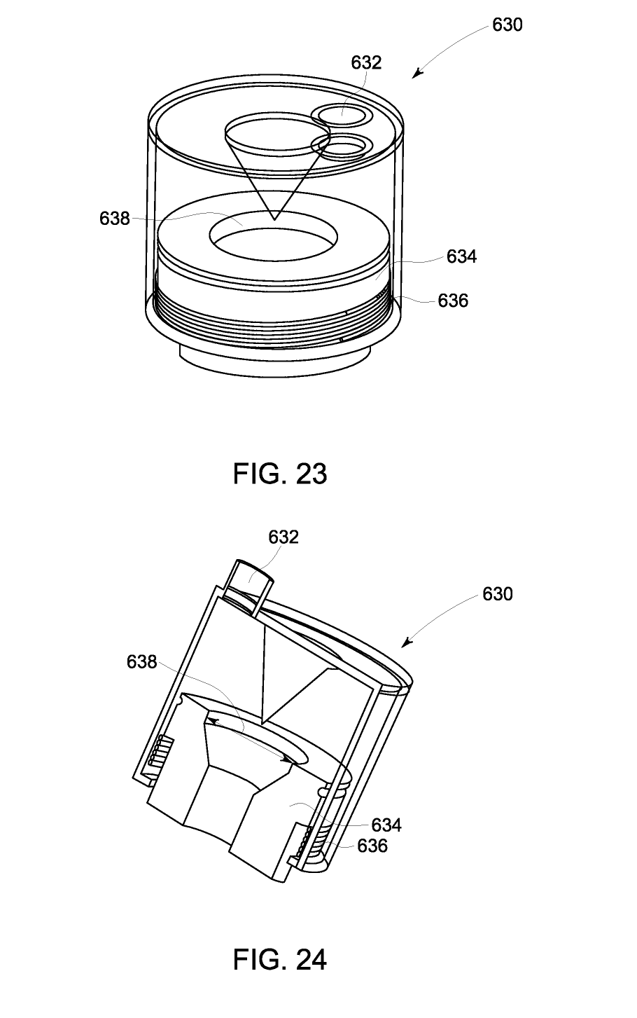

Referring to FIGS. 21-24, another embodiment of an anti-clogging nozzle 630 is shown. As shown therein, tractive material is supplied to the nozzle outlet by a passageway 632. The nozzle includes a plunger 634 that moves up and down by means of a spring 636, as the internal/upstream pressure within the nozzle 630 is varied. FIGS. 21 and 22 illustrates the plunger 634 and spring 636 position under normal operating conditions, i.e., when the nozzle 630 is not clogged. As shown therein, tractive material moves past the plunger 604 through passage 638 and is ejected from the nozzle 600. When abrasive particles agglomerate, however, as discussed above, flow of tractive material out of the nozzle is hindered and pressure builds upstream of the plunger 634. As pressure builds, the plunger 634 is forced downwards in the direction of arrow A, compressing the spring 636, as shown in FIGS. 23 and 24. As the plunger 634 is moved downwards, the area of the passage 638 is increased, thus allowing bigger abrasive particles to clear the orifice and the nozzle 630. After the larger abrasive particles have been dispensed out of the nozzle 630 and the nozzle 630 is clear, the spring 636 biases the plunger 634 to its default position, as shown in FIGS. 18 and 19, decreasing the area of the passage 638.

Anti-clogging nozzles, 600, 610, 620 and 630 may be self-actuatable in response to pressures within the nozzle. In an embodiment, the nozzles also may include a pneumatic actuator or electro-magnetic actuator to move the plunger in response to a signal from the controller. In an embodiment, the signal may be based on one or more of an elapsing time period, clog detection, or the measured slippage of the wheels (directly or indirectly).

The nozzle itself may be formed of a material sufficiently hard to resist appreciable wear from contact with and the high-speed flow of the tractive material. As disclosed above, in an embodiment, a wear resistant inner liner 508 may be utilized to resist wear from contact with the tractive material. In other embodiments, the entire nozzle may be cast from wear-resistant material. As discussed above, suitable wear-resistant materials include high strength metal alloys and/or ceramics.

In an embodiment, the nozzle may be one of a plurality of nozzles or the nozzle may define a plurality of apertures. Each aperture or nozzle may have a different angle of incidence relative to the contact surface. A manifold may be included which may be controlled by the controller to selectively choose the angle of incidence. The controller may determine the angle of incidence to initiate or maintain based at least in part on feedback signals from one or more electronic sensors. These sensors may measure one or more of the actual and direct angle of incidence, or may provide information that is used to calculate the angle of incidence. Such calculated angles may be based on, for example, the wheel diameter or a mileage of the corresponding wheel. If the mileage of the corresponding wheel is used then the controller may consult a wear table that models wheel wear over a determined amount of wheel usage. This may be a direct mileage measurement, or may itself be calculated or estimated. Methods for estimated mileage include a simple duration of use multiplied by the average speed, or by GPS location tracking. As the wheels are not replaced at the same intervals, individual wheels and wheel sets may be tracked individually to make these calculations. The controller instruction sets may use more than one indirect calculation to conservatively allow for such alignment and adjustments.

Referring back to the nozzle disclosed generally in FIG. 2, in an embodiment, the nozzle may be supported by a housing that is coupled to a truck frame or to an axle housing structure. In one embodiment, the nozzle may be oriented to direct the tractive material away from the wheel, and particularly so that the tractive material is substantially not present when the wheel contacts the contact surface. Such an orientation may be off to a side from the travel direction and angled towards the contact surface. The angle may be inward toward the center between two rails, or may be pointed wayside outwards from the track center. In an embodiment, the orientation of the nozzle may be front facing into the direction of travel and away from the wheel.

Rail wheels may have a single flange that rides on the inward side of a pair of rails. Thus, a stream traveling from inside the rails outward would first encounter or pass the flange before encountering the rail surface. In one embodiment, the aim of the nozzle may be directed around the flange portion of a flanged wheel. And, a nozzle pointing inward would emit a stream that would contact the rail surface prior to contacting the flange. The location and orientation of the nozzle, then, may be characterized in view of the flange location of the wheel. In one embodiment, an outward facing nozzle is directed to a rail contact surface in advance of the wheel/rail interface such that the flange is not an obstruction. In another embodiment, an inward facing nozzle is directed relatively more near the rail/wheel interface or at the rail/wheel interface (compared to an outward facing nozzle) owing to a pathway to the rail surface that is unobstructed by the flange.

In one embodiment, the nozzle is disposed above and horizontally outside the plurality of rails, and is oriented relative to the rail inward facing towards the plurality of rails. The nozzle may be oriented such that the flow is directed at the contact surface at a contact angle (angle of incidence) that is in a range of from about 75 degrees to about 85 degrees relative to a horizontal plane defined by the contact surface. The nozzle may be oriented further such that the flow is directed at the contact surface at a contact angle that is in a range of from about 15 degrees to about 20 degrees relative to a vertical plane defined by a direction of travel of the wheel. The contact angle can be measured such that the flow of tractive material is from the outside pointing inward towards the plurality of rails.

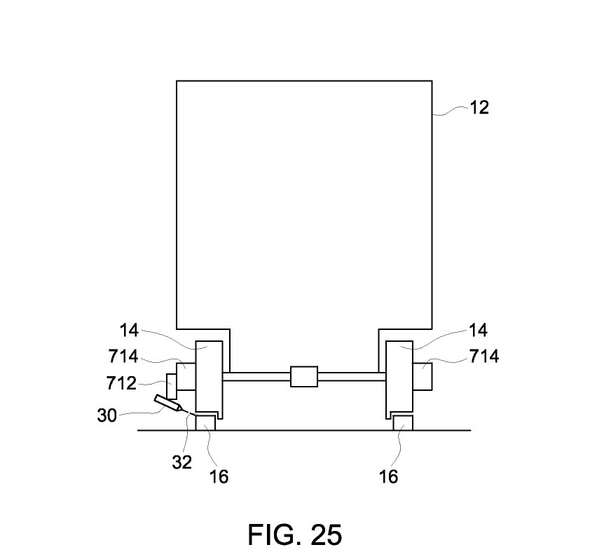

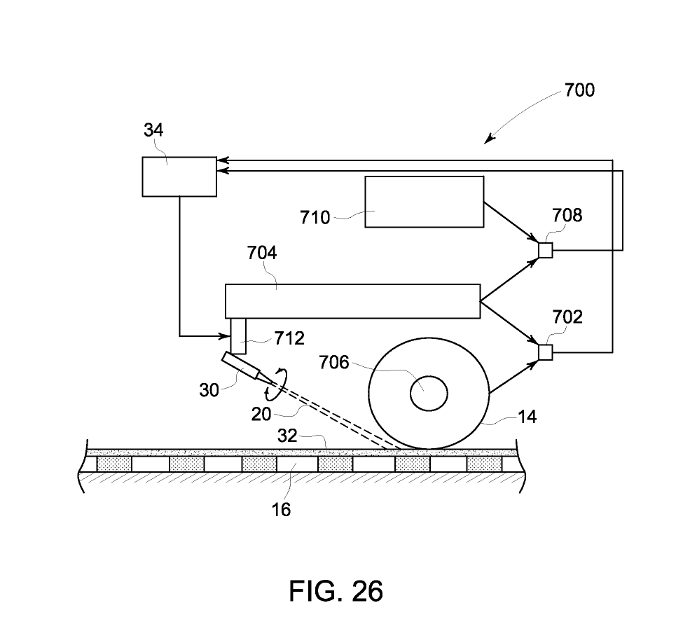

As shown in FIG. 25, in an embodiment, the nozzle 30 and nozzle alignment device may be mounted to and supported by a journal box 714 that is coupled to a powered axle of the vehicle 12. The nozzle may be supported from the journal box that is both one of a plurality of journal boxes and is the first journal box in the direction of travel of the vehicle 12. In an embodiment where the vehicle 12 is capable of moving forwards and backwards, the nozzle is supported from the journal box that is first or last, depending on whether the vehicle is traveling, respectively, forwards or backwards. In an embodiment, the nozzle may be supported from a journal box that is a subsequent journal box after the first journal box in the direction of travel of the vehicle that does not translate during a navigation of a curve by the vehicle. As discussed above and as further shown in FIG. 26, in an embodiment, the nozzle 30 is disposed above and laterally outside the rails 16 and is oriented relative to the rail inward facing from the rails 16.

The distance and the orientation of the nozzle from the desired point of impact may affect efficiency of the system. In one embodiment, the nozzle is less than a foot away from the contact surface. In various embodiments, the nozzle distance may be less than four inches, in a range of from about 4 inches to about 6 inches, from about 6 inches to about 9 inches, from about 9 inches to about 12 inches, or greater than about 12 inches from the contact surface. As disclosed above with regard to the flange arrangement, the flange location precludes some shorter distances from certain angles and orientations. Where the nozzle is configured to point from the inside of the rails outward, as the contact surface approaches the wheel/rail interface the distance must necessarily increase to account for the flange. Thus, systems used to blow snow, for example, away from the rails to prevent accumulation or build up between the rails have different constraints on location and orientation than a system with inward facing nozzles.

In an embodiment, the nozzle (or nozzles in embodiments where multiple nozzles are utilized) may respond to vehicle travel conditions or to location information (e.g., global positioning satellite (GPS) data) to maintain a determined orientation relative to the contact surface while the vehicle travels around a curve, upgrade, or down grade, as discussed in detail below. In response to a signal, the nozzle may displace laterally, displace up or down, or the nozzle distribution pattern of the tractive material may be controlled and/or changed. In an embodiment, the change to the pattern may be to change from a stream to a relatively wider cone, or from a cone to an elongate spray pattern. The nozzle displacement and/or distribution pattern may be based on a closed loop feedback based on measured adhesion or slippage. Further, the nozzle displacement may have a seeking mode that displaces and/or adjusts the dispersal pattern, and/or the flow rate or tractive material speed or pressure in the reservoir tank to determine a desired traction level or levels for any adjustable feature.

In an embodiment, in order to improve wheel-rail adhesion during braking and acceleration, tractive material may be dispensed from the nozzle(s) 30 and delivered at the wheel-rail interface, i.e., the area where the wheel contacts the rail. In addition, when the locomotive 12 is running on a straight track, tractive material is delivered between the wheel-rail interface to improve the adhesion. As the locomotive 12 traverses a curve, however, the end axles of the locomotive 12 move laterally and change the location of the wheel-rail interface, thereby reducing effectiveness of a system employing a fixed position nozzle.

In order to achieve a determined adhesion level, the nozzle angle with respect to the contact surface may be corrected continuously and in real-time in an embodiment. Operational input, including data about whether the vehicle is traveling on either straight or curved tracks, may be sensed continuously during travel to precisely deliver tractive material to the contact surface through the nozzle or the wheel/rail interface through the sand dispenser. As used herein, operational input can include input motion, model predictions, map or table based input that is based on vehicle location data, and the like. Input motion means linear motion between the axle or axle mounted components and the truck frame, and angular motion between the truck and car body.

In one embodiment, a system is provided for use with a wheeled vehicle that travels on a surface. The system includes the nozzle, and an air source for providing tractive material at a flow rate that is greater than 100 cubic feet per minute (2.83 cubic meters per minute) as measured as the tractive material exits the nozzle, and the air source is in fluid communication with the nozzle that receives the tractive material from the air source and directs a flow of the tractive material to a location on the surface that is a contact surface. The air source is a main reservoir equalization (MRE) tank or pipe of a locomotive, and the determined parameter is unregulated and is the same pressure as a pressure in the main reservoir equalization tank or pipe during operation of the vehicle.

A controller can respond to a signal based on operation of a compressor fluidly coupled to the MRE or to the sensed pressure in the main reservoir equalization tank or pipe and controls a valve that is capable of controlling or blocking the flow of tractive material from the air source to the nozzle. The controller is further capable of controlling operation of the compressor, and responds to operation of the compressor such that on/off cycling of the compressor above a threshold on/off cycling level by one or both of operating the compressor to reduce the on/off cycling or operating the valve to change the flow rate of the tractive material through the nozzle. The controller can respond to a sensed drop in the pressure in the main reservoir equalization tank or pipe that is below a threshold pressure level by reducing or blocking the flow of tractive material, and thereby to maintain the MRE pressure above the threshold pressure level.

During use, the media holding reservoir, if such is fluidly coupled to the nozzle, can provide particulate tractive material to fluidly combined or entrained in the flow of tractive material (air) that impacts the contact surface.

The system may include an adjustable mounting bracket for supporting the nozzle. A suitable adjustable mounting bracket may include bolts that secure the nozzle in a determined orientation when tightened, and that allow for repositioning of the nozzle and calibration of the nozzle aim when loosened. Manual adjustment and calibration can be performed periodically or in response to certain signals. The signals can include a change in the season or weather (as some orientations may work differently depending on whether the debris is water, snow or leaves) or a change in the vehicle condition (such as wheel wear or wheel replacement). Automatic or mechanical alignments are contemplated in connection with a system that provides feedback information for auto-alignment or alignment based on environmental or operational factors (such as navigating a curve).

A schematic illustration of a system 700 for nozzle directional alignment for use with the tractive effort systems disclosed above is shown in FIG. 26. In the illustrated embodiment, input motion is sensed continuously by one or more sensors operatively connected to the locomotive. In particular, a sensor 702 may continuously sense the linear motion between the truck 704 and the axle/axle mounted components 706. A sensor 708 may also continuously sense the angular motion between the truck 704 and the car body 710.

Suitable sensors may be mechanical, electrical, optical or magnetic sensors. In an embodiment, more than one type of sensor may be utilized. The sensors 702, 708, may be electrically coupled to the controller and may relay signals indicating truck versus axle motion and truck/carbody motion to the controller for conditioning. Optionally, there may be no signal conditioning. The controller sends a signal to a nozzle alignment device 712, which is operatively connected to the nozzle, to modify the orientation/angle of the nozzle instantaneously to ensure that tractive material is constantly delivered towards the wheel-rail interface, thereby improving the adhesion of the locomotive, especially around curves.

The nozzle alignment device may be operated mechanically, electrically, magnetically, pneumatically or hydraulically, or a combination thereof to adjust the angle of the nozzle with respect to the contact surface of the rail. In an embodiment, the nozzle directional alignment system also may be used to control the alignment of the sand dispenser, in the same manner as described above.

The controller may receive signals from sensors, as discussed above, or from a manual input, and may control various features and operations of the tractive effort system. For example, the controller may control one or more of the on/off state of the system, a flow rate of the tractive material, or the speed of the tractive material through the nozzle. Such control may be based on one or more of the speed of the vehicle relative to the track, the amount of debris on the track, the type of debris on the track, a controlled loop feedback of the amount or type of debris on the track actually being removed by the tractive material, the type of track, the condition of the contact surface of the track, a controlled loop feedback based at least in part on detected slippage of the wheel on the track, and the geographic location of a vehicle comprising the wheel such that the tractive material is directed or not directed to the contact surface in certain locations. That is, the controller can deploy the tractive material in response to an external signal that includes one or both of travel conditions or location information.

With further reference to the operation of the controller, in an embodiment, it may receive sensor input that detects a pressure level in the reservoir tank or pressure vessel, and may control the deployment of the tractive material only when the pressure level is in a determined pressure range. In an embodiment, the controller may control the pressure level in the reservoir or the pressure vessel 202 by activating an air compressor. The deployment of the tractive material, by the controller, can be continuous or pulsed/periodic. The pulse duration and frequency may be set based on determined threshold levels. These levels may be the measured or estimated amount of tractive material available, the time until the tractive material can be replenished, the season of the year and/or geography (which may indirectly indicate the type and quantity of leaves or snow), and the like. In one embodiment, the controller can cease deployment of the tractive material in response to a direct or indirect adhesion level being outside of determined threshold values. Outside the threshold values includes an adhesion that is too low, naturally, but also if too high or at least sufficient so as to conserve the tractive material reserve. And, if the adhesion level is too low even after deployment of the tractive material, and if the seeking mode is not present or is not successful, and if there is no indication of a clog, then the controller may conserve the tractive material merely because there is no desired improvement.

In one embodiment, the controller can deploy, or suspend deployment, of the tractive material based on location or the presence of a particular feature or structure. For example, in the presence of a wayside lubricator station the controller may suspend deployment. In other embodiments, it may be set to only deploy tractive material when on a curve or grade. Location may be provided by GPS data, as discussed above, by a route map, or by a signal from the structure or features (e.g., an RFID signature). For example, a rail yard may have a defined zone, communicated to the controller, in which the controller will not actuate the tractive effort system.

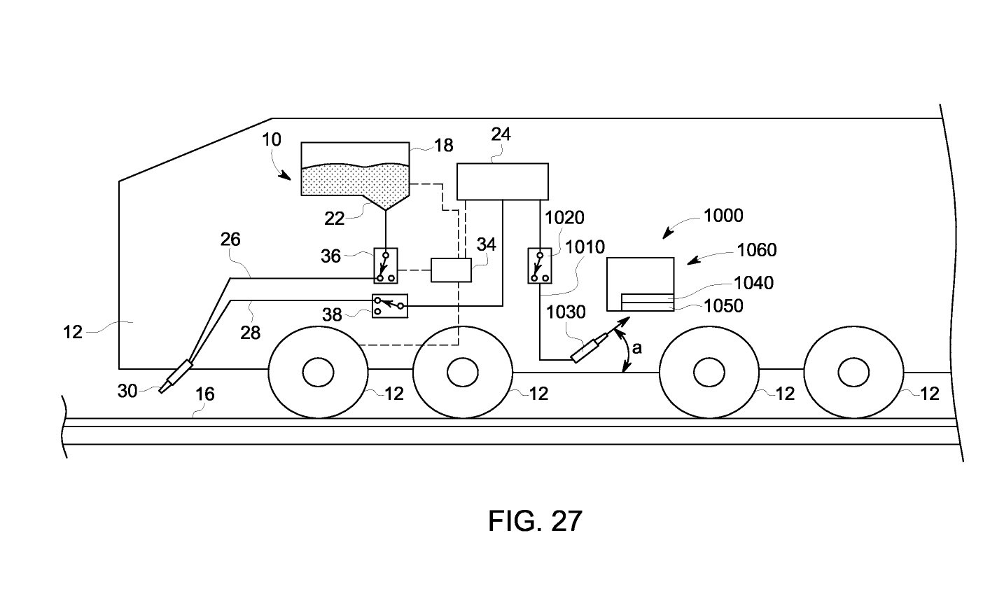

Embodiments of the invention further relate to a system and method for maintaining sensor performance. In certain embodiments, the inventive system may be configured for use with a rail vehicle, such as the rail vehicle of FIG. 1. Referring to FIG. 27 a schematic diagram illustrating a system for maintaining sensor performance 1000 according to an embodiment of the invention is shown. In the illustrated embodiment, the system 1000 is deployed on a rail vehicle 12 that has at least one wheel 14 for traveling over a rail 16. As shown, the system 1000 is configured to be used with an onboard tractive effort system that includes an air reservoir 24 containing pressurized air, or other gas, (e.g., it may be the storage tank of an air compressor). In an embodiment, the air reservoir 24 may be an existing component/system of the vehicle 12, such as the MRE. Alternatively, the system 1000 may utilize a reservoir dedicated to optical sensor cleaning or tractive effort along with optical sensor cleaning. It should also be appreciated that the inventive system may be used independently from a tractive effort system and, indeed, may be used on rail vehicles that are not equipped with such systems. As discussed in greater detail herein, more generally, embodiments of the inventive system may dispense a pressurized fluid and thus include a fluid reservoir. Accordingly, as used herein, the terms “fluid reservoir,” “gas or other fluid reservoir.” “fluid valve,” and “gas or other fluid valve” refer to a reservoir and valve, respectively, that are configured to contain/dispense, for example, air, other non-air gases, mixtures of air and other gases, and/or other fluids, including liquids such as, for example, pressurized water or cleaning solution.

Referring again to FIG. 27, in certain embodiments the system 1000 may share the reservoir 24 with an onboard tractive effort system 10 which is described in greater detail above. In this embodiment, the air reservoir 24 includes a conduit 35 connecting it to nozzle 30 of the tractive effort system, as well as a conduit 1010, which connects the reservoir 24 to the sensor maintenance system 1000. The conduit 1010 includes an air valve 1020 disposed between the reservoir 24 and at least one nozzle (or nozzles) 1030 through which the air flows. In certain embodiments, the reservoir 24 may be coupled to a heater (not shown) to deliver heated pressurized air to the optical sensor.

As depicted, the nozzle 1030 is positioned to direct pressurized air at an optical inspection sensor assembly 1060. In an embodiment, the pressurized air is directed to a transparent sensor window or shield 1050 which is positioned over the optical sensor unit 1040 to protect the same. In embodiments, the shield 1050 has first and second sides and the sensor unit 1040 is disposed on a first side and the second side defines the surface at which the pressurized air is directed. As shown, nozzle 1030 is positioned such that it can effectively clear or scrub the shield 1050 from contaminants. As discussed in greater detail below, the nozzle 1030 may also be positioned to create an air “curtain” about the sensor assembly 1060.

In certain embodiments, the transparent shield is glass or a glass-coated polymer layer, or other coated glass. The shield may include a body layer and a transparent coating layer affixed to the body layer where it forms/defines the second side of the shield. In embodiments, the coating layer has a hardness of at least 2 GPa as measured by micro-indentation. For example, the coating may include Diamondshield® coating available from Morgan Advanced Ceramics.

As further shown therein, embodiments of the system include a controller 34 that controls the supply of the pressurized air from the air reservoir 24. In an embodiment, the controller is operably coupled to the air valve 1020 and can switch the valve between a first state or position in which the air can flow to the nozzle 1030 and a second state or position in which air cannot flow to the nozzle. The first and second states may be open and closed states, respectively. As will be appreciated, the controller may be used to rapidly open and close the air valve 1020 to create a pulsed or periodic air flow from each nozzle.

The controller's delivery of pressurized air to the optical sensor may be periodic, e.g., weekly, or or other predetermined period sufficient for the optical sensor to collect contaminants, or based on other factors. These include ambient environmental conditions, optical sensor performance data or feedback, and/or the measurement of build up of contaminants, e.g., dirt, grit and the like on the optical sensor itself. In certain embodiments, the system may further include a second sensor 1062 that detects the presence of contaminants on the optical inspection sensor assembly 1060.

As will be appreciated, the system 1000 may utilize the same controller 34 as the tractive effort system 100. In this embodiment, the controller is capable of controlling air flow through the nozzle 1030 as well as tractive material and/or air through a media valve 36 and tractive effort nozzle 30. Indeed, the system 1000 may be utilized in connection with tractive effort systems 10, 100, 200, 300, 400, which have been previously discussed herein and may share other components such as feedback or monitoring sensors.

In addition to opening and closing valve 1020, the controller 34 may also control the pressure, flow rate and/or velocity of the air from the air reservoir. With respect to pressure, in certain embodiments, the air pressure is greater than about 90 psi, or in a range of from about 90 psi to about 100 psi, from about 100 psi to about 110 psi, from about 110 psi to about 120 psi, from about 120 psi to about 130 psi, or from about 130 psi to about 140 psi. In one embodiment on a locomotive, the air pressure is at the same pressure as the compressor supplied air used for the air brake reservoir (˜135 psi), and may therefore be operated without the addition of an air pressure regulator.

With regard to air flow, the system may operate at flow rates of greater than 30 cubic feet per minute (CFM) for a pair of nozzles (each nozzle would have half of the value), or in a range of from about 30 CFM to about 75 CFM, from about 75 CFM to about 100 CFM, from about 100 CFM to about 110 CFM, from about 110 CFM to about 120 CFM, from about 120 CFM to about 130 CFM, from about 130 CFM to about 140 CFM, from about 140 CFM to about 150 CFM, from about 150 CFM to about 160 CFM, or greater than about 160 CFM for a nozzle pair.

With regard to air velocity, the system may operate at an impact velocity of greater than 75 feet per second (FPS), or in a range of from about 75 FPS to about 100 FPS, from about 100 FPS to about 200 FPS, from about 200 FPS to about 300 FPS, from about 300 FPS to about 400 FPS, from about 400 FPS to about 450 FPS, from about 450 FPS to about 500 FPS, from about 500 FPS to about 550 FPS, or greater than about 550 FPS.

The controller may adjust the flow rates, for example, based on parameters such as vehicle speed and direction, incident wind, sensed contaminants, rain, snow, and other environmental conditions surrounding the vehicle. Moreover, in certain embodiments, if the MRE pressure drops below a threshold value, the controller 34 may reduce or eliminate the air flow of the inventive system until the MRE pressure is restored to a defined pressure level.

In certain embodiments of the inventive system, the nozzle or nozzles may direct a liquid, such as a pressurized cleaning solution, toward an optical inspection sensor assembly to remove contaminants from the same. These embodiments would utilize a fluid reservoir (configured for holding a liquid), at least one fluid nozzle (configured for dispensing a liquid), a fluid valve (configured for controlling a liquid flow) between the reservoir and nozzle, and a controller. As will be appreciated, the controller may adjust pressure, flow rate and/or impact velocity of the liquid as described above. In certain embodiments, the temperature of the liquid can be adjusted via a heating or cooling apparatus.

While FIG. 27 shows a single nozzle 1030, multiple nozzles may be employed without departing from the broader aspects of the invention. Multiple nozzles may operate independently or in a coordinated fashion under the direction of the controller. In an embodiment, multiple nozzles are employed to create a continuous “curtain” of air that opposes the incident airflow created by vehicle travel (FIG. 31). In addition to the curtain created by one or more nozzles, other nozzles in a multi-nozzle system may periodically scrub the sensor.

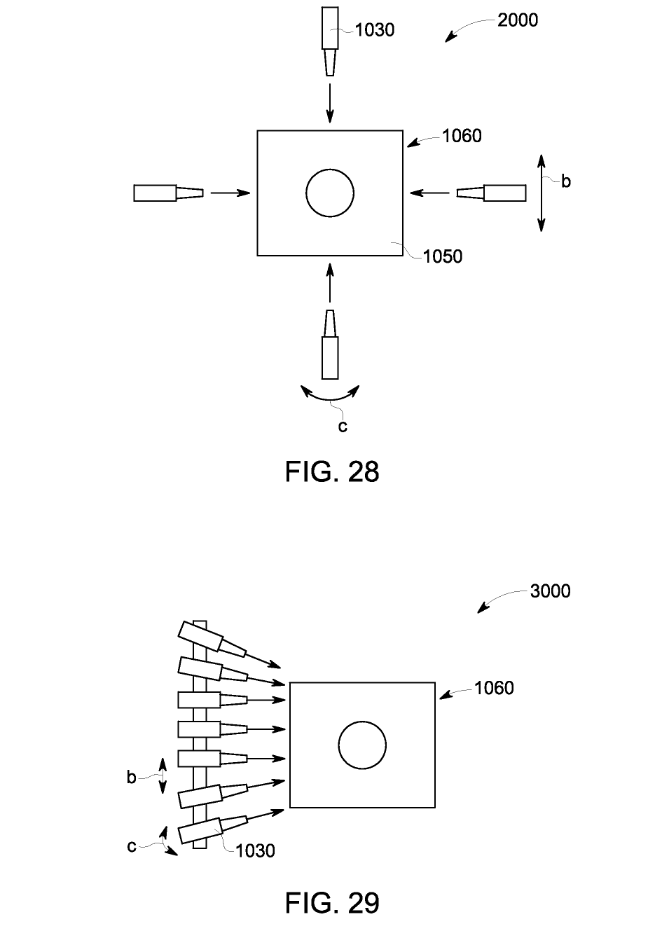

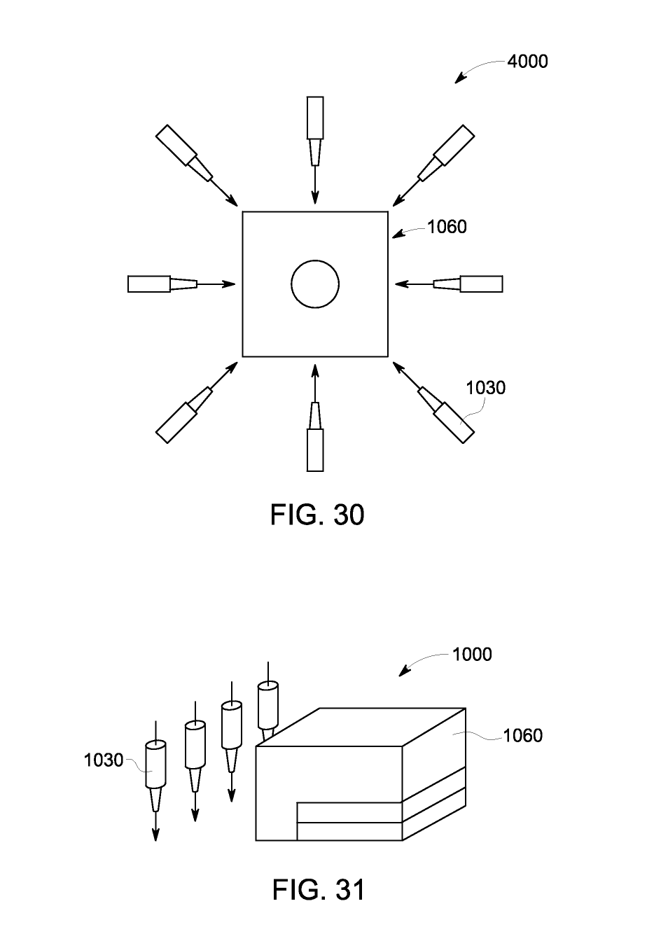

Referring now to FIGS. 28-30, various configurations multiple nozzles 1030 may be utilized. For example, in FIG. 28 shows an arrangement of four nozzles 1030, one per side of the sensor 1050, and FIGS. 29 and 30 depict an array and circumferential nozzle arrangements respectively. Regardless of the arrangement, it may be desirable to be able to adjust the nozzle to selectively direct airflow. As such, nozzles may be moved along direction b, or may be rotated about an axis in direction c. Moreover, referring back to FIG. 27, the angle a of the nozzle 1030 may be varied to optimize system 1000 performance. The nozzles 1030 may be moved independently of one another so that some nozzles can be used to create a curtain while others can scrub the sensor.

As will be appreciated, the distance and the orientation of the nozzles from the desired point of impact may affect efficiency of the system. In one embodiment, the nozzle is less than a foot away from the optical sensor. In various embodiments, the nozzle distance may be less than four inches, in a range of from about 4 inches to about 6 inches, from about 6 inches to about 9 inches, from about 9 inches to about 12 inches, or greater than about 12 inches from the sensor.

In an embodiment, the nozzle (or nozzles in embodiments where multiple nozzles are utilized) may respond to vehicle travel conditions or to location information (e.g., global positioning satellite (GPS) data) to maintain a determined orientation relative to the optical sensor while the vehicle travels around a curve, upgrade, or down grade, as discussed in detail below. In response to a signal, the nozzle may displace laterally, displace up or down, or the nozzle distribution pattern of the pressurized air may be controlled and/or changed. In an embodiment, the change to the pattern may be to change from a stream to a relatively wider cone, or from a cone to an elongate spray pattern. The nozzle displacement and/or distribution pattern may be based on a closed loop feedback based on sensor performance.

The nozzle angle a with respect to the optical sensor may be corrected continuously and in real-time in an embodiment. Operational input, including data about vehicle's travel speed, ambient conditions, etc., may be sensed continuously during travel to precisely deliver air to the optical sensor assembly 1060 through each nozzle. As used herein, operational input can include input motion, model predictions, map or table based input that is based on vehicle location data, and the like. Input motion means linear motion between the axle or axle mounted components and the truck frame, and angular motion between the truck and car body.

The system may include an adjustable mounting bracket for supporting the nozzle or array of nozzles. A suitable adjustable mounting bracket may include bolts that secure the nozzle in a determined orientation when tightened, and that allow for repositioning of the nozzle and calibration of the nozzle aim when loosened. Manual adjustment and calibration can be performed periodically or in response to certain signals such as a measured decrease in optical sensor performance.

Referring to the nozzle disclosed generally in FIGS. 27-30, nozzle may be supported by a housing that is coupled to a truck frame or to an axle housing structure. The nozzle may be oriented to a side from the travel direction and angled towards the optical sensor assembly. The angle may be inward toward the center between two rails, or may be pointed wayside outwards from the track center. In an embodiment, the orientation of the nozzle may be front facing into the direction of travel to create a curtain. The nozzle may be attached via a journal box or other structure.

Referring back to FIGS. 8-24, the nozzles of the sensor maintenance system 1000 may be anti-clogging nozzles as depicted and described above in greater detail. Moreover, the nozzle itself may be formed of a material sufficiently hard to resist appreciable wear. In an embodiment, a wear resistant inner liner may be utilized to resist wear. In other embodiments, the entire nozzle may be cast from wear-resistant material. As discussed above, suitable wear-resistant materials include high strength metal alloys and/or ceramics.

In certain embodiments, various attachments may be coupled to nozzles. Suitable attachments may include, for example, heaters, and the like. In one embodiment, a secondary nozzle may be present for supplying liquid, e.g., water or a solution, to the optical sensor assembly. The solution may be a solvent or may be a cleanser, such as a soap or detergent solution.

Further, in embodiments, a single nozzle may define a plurality of apertures. Each aperture may have a different angle of incidence relative to the optical sensor assembly. A manifold may be included which may be controlled by the controller to selectively choose the angle of incidence.

In an embodiment, a system for use with a vehicle includes at least one nozzle and a gas or other fluid reservoir capable of holding a volume of pressurized gas or other fluid. The gas or other fluid reservoir is in fluid communication with the at least one nozzle and the at least one nozzle is selectively operable to direct the pressurized gas or other fluid at a surface of an optical inspection sensor assembly to remove contaminants from the sensor assembly.

In embodiments, the at least one nozzle includes a plurality of nozzles and in certain embodiments the at least one nozzle includes an array of nozzles. The system can further include a gas or other fluid valve in fluid communication with the gas or other fluid reservoir and the at least one nozzle, the valve being controllable between a first state in which the pressurized gas or other fluid flows through the valve and to the at least one nozzle, and a second state in which the pressurized gas or other fluid is prevented from flowing to the at least one nozzle. The gas or other fluid reservoir may be coupled to a heater for heating the pressurized gas or other fluid.

In embodiments, the system further includes a controller configured to direct the at least one nozzle to release the pressurized gas or other fluid in response to a signal. In certain embodiments, the controller is configured to direct the at least one nozzle to release the pressurized gas or other fluid in dependence upon at least one of vehicle travel conditions or location information or to direct the at least one nozzle to release the pressurized gas of other fluid in dependence upon the performance of the optical inspection sensor assembly.

In embodiments, the system may further include a second sensor that detects the presence of contaminants on the surface of the optical inspection sensor assembly and the controller is configured to direct the nozzle to release the pressurized gas or other fluid in dependence upon the presence of contaminants on the optical inspection sensor assembly.

In certain embodiments, the system may further include a media reservoir capable of holding a tractive material that includes particulates, a tractive material nozzle in fluid communication with the media reservoir; and a media valve in fluid communication with the media reservoir and the tractive material nozzle, the media valve being controllable between a first state in which the tractive material flows through the media valve and to the tractive material nozzle, and a second state in which the tractive material is prevented from flowing to the tractive material nozzle, and in the first state the tractive material nozzle receives the tractive material from the media reservoir and directs the tractive material to a contact surface such that the tractive material impacts the contact surface that is spaced from a wheel/surface interface and to thereby modify the adhesion or the traction capability of the contact surface with regard to a subsequently contacting wheel.

In embodiments, the system further includes a controller electrically coupled to the media valve and the gas or other fluid valve for controlling the media valve and the gas or other fluid valve between the first states and the second states, respectively and a controller that operates to control a flow rate of pressurized gas or other fluid, of tractive material, or both pressurized air and tractive material through the tractive material nozzle and pressurized gas or other fluid through the gas or other fluid nozzle.

In another embodiment of the system, the optical inspection sensor assembly includes a sensor unit and a transparent shield having a first side and a second side, the sensor unit disposed on the first side, and the second side defining the surface at which the pressurized gas or other fluid is directed. In another embodiment, the transparent shield includes glass, e.g., only glass, or a glass-coated polymer layer.

In another embodiment of the system, the transparent shield includes a transparent body layer and a transparent coating layer affixed to the body layer. The transparent coating forms/defines the second side of the transparent shield. The transparent coating layer has a hardness of at least 2 GPa as measured by micro indentation. For example, the coating may comprise Diamondshield® coating available from Morgan Advanced Ceramics. The transparent coating may be hydrophobic in certain embodiments.

In another embodiment of the system, the optical inspection sensor assembly is disposed on an undercarriage of the vehicle for the optical inspection sensor assembly to sense a route under the vehicle over which the vehicle travels.

In another embodiment, a system for use with a vehicle includes a nozzle configured to receive pressurized gas or other fluid from a reservoir and direct the pressurized gas or other fluid to an optical sensor assembly. The system further includes a second sensor configured to detect operational data and a controller in electrical communication with the second sensor for receiving the operational data therefrom, the controller being operable to change at least one of a flow rate, a pressure, a velocity, or an angle of incidence of the pressurized gas or other fluid in dependence upon the operational data.

In another embodiment, a system includes an array of nozzles, each nozzle having a respective body defining a passageway therethrough and having an inlet for accepting pressurized air and an outlet for directing pressurized gas or other fluid onto an optical inspection sensor assembly.

In an embodiment, a method is provided that includes controlling a flow of pressurized gas or other fluid from an gas or other fluid reservoir to a nozzle that is oriented toward an optical inspection sensor assembly attached to a vehicle and impacting the optical inspection sensor assembly with the flow of pressurized gas or other fluid to remove contaminants from the sensor assembly.

In another embodiment, a system for use with a vehicle comprises at least one nozzle, and a reservoir capable of holding a volume of pressurized fluid. The reservoir is in fluid communication with the at least one nozzle. The at least one nozzle is selectively operable to direct the pressurized fluid at a surface of an optical inspection sensor assembly to remove contaminants from the sensor assembly. In another aspect, the optical inspection sensor assembly is not associated with an operator cab of the vehicle, e.g., the optical inspection sensor assembly is not associated with and does not include a windshield or window of the operator cab of the vehicle. In another aspect, the optical inspection sensor assembly comprises a transparent shield or other member, and the at least one nozzle is selectively operable to direct the pressurized fluid at the transparent shield or other member to remove contaminants from the transparent shield or other member. In another aspect, the transparent shield or other member is directly associated with a sensor of the optical inspection sensor assembly, meaning there are no other transparent shields or other members disposed between the transparent shield (or other member) and the sensor.

The above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. In the appended claims, the terms “including” and “in which” are used as the plain-English equivalents of the respective terms “comprising” and “wherein.” Moreover, in the following claims, the terms “first,” “second,” “third,” “upper,” “lower,” “bottom,” “top,” etc. are used merely as labels, and are not intended to impose numerical or positional requirements on their objects, unless otherwise stated.

As used herein, an element or step recited in the singular and proceeded with the word “a” or “an” should be understood as not excluding plural of said elements or steps, unless such exclusion is explicitly stated. Furthermore, references to “one embodiment” of the invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

This written description uses examples to disclose several embodiments of the invention, including the best mode, and also to enable one of ordinary skill in the art to practice the embodiments of invention, including making and using any devices or systems and performing any incorporated methods.

What is claimed is:

1. A system for use with a vehicle, comprising:
at least one nozzle; and
a reservoir capable of holding a volume of pressurized fluid, the reservoir being in fluid communication with the at least one nozzle;
wherein the at least one nozzle is selectively operable to direct the pressurized fluid at a surface of an optical inspection sensor assembly to remove contaminants from the sensor assembly.

2. The system of claim 1, wherein the at least one nozzle comprises a plurality of nozzles.

3. The system of claim 1, wherein the at least one nozzle comprises an array of nozzles.

4. The system of claim 1, wherein the reservoir is an air reservoir, the pressurized fluid is pressurized air, and the at least one nozzle is selectively operable to direct the pressurized air at the surface of the optical inspection sensor assembly.

5. The system of claim 1, further comprising:
a valve in fluid communication with the reservoir and the at least one nozzle, the valve being controllable between a first state in which the pressurized fluid flows through the fluid valve and to the at least one nozzle, and a second state in which the pressurized fluid is prevented from flowing to the at least one nozzle.

6. The system of claim 1, further comprising:
a controller configured to direct the at least one nozzle to release the pressurized fluid in response to a signal.

7. The system of claim 6, wherein the controller is configured to direct the at least one nozzle to release the pressurized fluid in dependence upon at least one of vehicle travel conditions or location information.

8. The system of claim 6, wherein the controller is configured to direct the at least one nozzle to release the pressurized fluid in dependence upon the performance of the optical inspection sensor assembly.

9. The system of claim 6, further comprising:
a second sensor that detects the presence of contaminants on the surface of the optical inspection sensor assembly.

10. The system of claim 9, wherein the controller is configured to direct the nozzle to release the pressurized fluid in dependence upon the presence of contaminants on the optical inspection sensor assembly.

11. The system of claim 1, wherein the air reservoir is coupled to a heater for heating the pressurized fluid.

12. The system of claim 1, further comprising a media reservoir capable of holding a tractive material that includes particulates;
a tractive material nozzle in fluid communication with the media reservoir; and
a media valve in fluid communication with the media reservoir and the tractive material nozzle, the media valve being controllable between a first state in which the tractive material flows through the media valve and to the tractive material nozzle, and a second state in which the tractive material is prevented from flowing to the tractive material nozzle, and in the first state the tractive material nozzle receives the tractive material from the media reservoir and directs the tractive material to a contact surface such that the tractive material impacts the contact surface that is spaced from a wheel/surface interface and to thereby modify the adhesion or the traction capability of the contact surface with regard to a subsequently contacting wheel.

13. The system of claim 12, further comprising a controller electrically coupled to the media valve and the fluid valve for controlling the media valve and the fluid valve between the first states and the second states, respectively.

14. The system of claim 12, further comprising a controller that operates to control a flow rate of pressurized fluid, of tractive material, or both pressurized fluid and tractive material through the tractive material nozzle and pressurized fluid through the fluid nozzle.

15. The system of claim 1, wherein the optical inspection sensor assembly comprises a sensor unit and a transparent shield having a first side and a second side, the sensor unit disposed on the first side, and the second side defining the surface at which the pressurized fluid is directed.

16. The system of claim 15, wherein the transparent shield comprises glass.

17. The system of claim 15, wherein the transparent shield comprises a transparent body layer and a transparent coating layer affixed to the body layer, the transparent coating forming the second side of the transparent shield, and wherein the transparent coating layer has a hardness of at least 2 GPa as measured by micro indentation.

18. The system of claim 17, wherein the transparent coating is hydrophobic.

19. The system of claim 15, wherein the optical inspection sensor assembly is disposed on an undercarriage of the vehicle for the optical inspection sensor to sense a route under the vehicle over which the vehicle travels.

20. A system for use with a vehicle, comprising:
a nozzle configured to receive pressurized fluid from a reservoir and direct the pressurized fluid to an optical sensor assembly;
a second sensor configured to detect operational data; and
a controller in electrical communication with the second sensor for receiving the operational data therefrom, and the controller being operable to change at least one of a flow rate, a pressure, a velocity, or an angle of incidence of the pressurized fluid in dependence upon the operational data.

21. A system comprising:
an array of nozzles, each nozzle having a respective body defining a passageway therethrough and having an inlet for accepting pressurized fluid and an outlet for directing pressurized fluid onto an optical inspection sensor assembly.
